(19) United States
(12) Patent Application Publication
(10) Pub. No.: US 2005/0162384 A1
(43) Pub. Date: Jul. 28, 2005

(54) Pointing device, method for displaying point image, and program therefor

(75) Inventor: Junichi Yokoyama, Saitama (JP)

Correspondence Address: OLIFF & BERRIDGE, PLC, P.O. BOX 19928, ALEXANDRIA, VA, 22320, US

(73) Assignee: FUJINON CORPORATION, Saitama-shi (JP)

(21) Appl. No.: 11/042,508

(22) Filed: Jan. 26, 2005

(30) Foreign Application Priority Data
Jan. 28, 2004 (JP) 2004-019452
Jun. 11, 2004 (JP) 2004-173867
Jul. 29, 2004 (JP) 2004-221608

(51) Int. Cl. G03B 7/099

(52) U.S. Cl. 345/156

(57) ABSTRACT

A pointing device has an image indicating device; a photographing device provided in the image indicating device; an image movement detecting device for detecting a movement of a photographed image photographed by the photographing device; a calculating device for calculating a moving direction and a moving distance of a point image corresponding to the movement of the image; and a signal generating device for generating a signal for synthesizing the point image with a displayed image, wherein the position of the displayed point image is moved in accordance with the movement of the image photographed by the photographing device.

### BACKGROUND OF THE INVENTION

1. Field of the Invention

The present invention relates to a pointing device, a displaying method for a point image, and a program for displaying a point image on a projected image or a display screen.

2. Description of the Related Art

A method in which an image is projected on a screen and a presentation is performed by using the image is known. In this case, in order to indicate a specific position on the image, a point image is displayed on the image. For example, the point image is a light spot or an image of an arrow.

The above technique is disclosed in Japanese Patent Unexamined Application Publication No. 2002-207566 (hereinafter referred to simply as “Document D1”), in Japanese Patent Unexamined Application Publication No. 11-271675 (hereinafter referred to simply as “Document D2”), in Japanese Patent Unexamined Application Publication No. 11-305940 (hereinafter referred to simply as “Document D3”), and in Japanese Patent Unexamined Application Publication No. 11-85395 (hereinafter referred to simply as “Document D4”). The technique in the Document D1 is structured such that a point image is displayed on an image projected by an image projecting device onto a screen. In the technique, an ultrasonic wave is generated by an image indicating device for operating a point image, and is sensed by a sensor provided on a screen side, whereby a position indicated by the image indicating device is specified and a point image is displayed on the screen.

In the Documents D2 and D3, an infrared ray or an indication light is irradiated by an image indicating device, and the irradiated position on a screen is specified, whereby a position of a displayed point image is controlled.

The technique in Document D4 is structured such that an infrared ray is irradiated by an image indicating device on a screen and a position of a displayed point image is thereby determined. In the technique, a reference position for coordinate detection is projected on the screen.

However, in the technique in which an ultrasonic wave is used as shown in the Document D1, a receiving device for sensing an ultrasonic wave is required on the screen side, the number of devices is increased, and the structure is complicated. In the techniques in which an infrared ray or an indication light is used as shown in the Documents D2 to D4, devices and structures for sensing an infrared ray or an indication light are required, whereby the techniques in the Documents D2 to D4 have the same problems as that of the Document D1.

In the above techniques, it is necessary to set the positions of the image indicating device and the point image beforehand. However, since presentations are performed in various setting environments, it is troublesome and inconvenient to perform setting of the above positions every time the above techniques are used. In the above techniques, when the image indicating device is not directed to the screen, the position of the point image cannot be controlled. In a presentation, since the image indicating device is always directed at the screen, the position, the direction, and the motion (in particular, the motion of the hand with the image indicating device) of the presenter is restricted.

Although a laser pointer is known as the above pointing device, it is dangerous and unpleasant when a laser beam is directly irradiated into the eyes of the audience. In other methods for using the above laser pointer, a point image as a mark such as an arrow is displayed on a screen, and is moved thereon (see Japanese Patent Unexamined Application Publication No. 2002-154083 (hereinafter referred to simply as a “Document D5”) and the Document D2).

However, in the above methods in the Documents D2 and D5, since it is necessary for the presenter to direct the pointing device at the screen, the motion of the presenter is restricted.

An image display function for displaying an image onto a screen is researched so as to be applied to lessons and lectures. For example, it is thought that an image display function may be applied to a math lesson in which an answer on a note written by a student is displayed on a screen. In order to realize the above method, a digital still camera or a compact handy camera is used.

However, in the above case, since the teacher is required to explain by using the above pointing device and operating the camera, the pointing device is a difficult hardware to use.

### SUMMARY OF THE INVENTION

An object of the present invention is to provide a technique which can solve the above conventional problems of the point image control technique, prevents an increase in the number of devices, can have a simple structure, does not require troublesome alignment, and can control a point image without directing an image indicating device at a screen.

Another object of the present invention is to provide a technique which facilitates operating a point image and displaying a photographed image onto a screen in presentations or lessons performed by using an image displayed on the screen.

The present invention provides a pointing device including: an image indicating device for operating a point image; a photographing device for photographing, which is provided in the image indicating device; an image movement detecting device for detecting a movement of a photographed image photographed by the photographing device; a calculating device for calculating a moving direction and a moving distance of the point image corresponding to the movement of the photographed image; and a signal generating device for generating a signal for synthesizing the point image with a displayed image, wherein the position of the displayed point image is moved in accordance with the movement of the photographed image by the photographing device.

In the pointing device of the present invention, the image indicating device may be desirably equipped with a CCD camera for photographing. The CCD camera can have a compact size and a high resolution. It is convenient to simply use the image indicating device as a camera.

According to the present invention, the moving direction and the moving distance of the point image are calculated from the movement of the photographed image (that is, the movement of the photographed image within the photographed view), so that the position control of the point image is performed. In the present invention, the change of the directing direction of the image indicating device is detected based on the movement of the image within the photographed view which is photographed by the image indicating device. Based on the result of the detection, the position of the displayed point image can be moved in accordance with the change of the directing direction of the image indicating device by moving the position of the displayed point image.

In the pointing device of the present invention, since the movement of the image photographed by the photographing device is detected by the image indicating device, a sensor is not required except for the photographing element of the image indicating device, and the overall system can thereby be simple. Since the relative movement of the directing position of the image indicating device is detected, the position of the point image can be controlled while the image indicating device is directed to an appropriate location, troublesome alignment operation is not required. Since the movement of the point image is controlled based on the relative movement of the image within the photographed view, the image indicating device can be directed in an arbitrary direction, so that the freedom of using the pointing device is large. As a result, for example, in the case in which the image indicating device is used in a presentation, restriction of the pose, direction, and motion of the presenter is reduced.

In the pointing device of the present invention, it is desirable that the pointing device have plural monitor points which are set within the photographed image; the image movement detecting device store first image data at one or more monitor points at a predetermined time, compare second image data which is obtained at the plural monitor points after the predetermined time with the stored first image data, detect difference between the first image data and the second image data based on the result of the comparison, and calculate the moving direction and the moving distance of the photographed image based on the difference between the first image data and the second image data.

In the above feature, image data obtained at the monitor point at predetermined time intervals are compared, so that the movement of the photographed image can be detected, and the moving direction and the moving distance thereof can be calculated. In the above feature, since only the images at the monitor points which are set at predetermined plural positions of the photographed image are analyzed, the use information content can be reduced. As a result, the cost and the processing time can be reduced. In particular, since the processing time can be reduced, the movement of the point image can smoothly follow the movement of the image indicating device.

In processing by the above image movement detecting device, the monitor point may desirably have pixels divided in the form of a matrix. In the feature, since image data is used as dot information of the pixels arranged in the form of a matrix, the processing of image data can be easy.

The pointing device of the present invention may be desirably equipped with a position control device for displaying the point image at a predetermined position unrelated to the result of the calculation by the calculating device. In the feature, the point image can be initially displayed at a predetermined position unrelated to the directing position of the image directing device. For example, this function can be used in the case in which the point image is missing. In the feature, there is no need of troublesome alignment, and it is convenient to use.

The pointing device of the present invention may be desirably equipped with a graphical user interface (GUI) operating device in which the point image is used. In the feature, for the image projected from the projecting device onto the screen, the personal computer can be used by using the GUI operating device.

That is, in a presentation in which an image projected onto a large screen is used, the GUI operation in which the point image is used is performed, and reference processing of various materials can be easily performed by a click operation on the projected image.

In the pointing device of the present invention, an adjusting device which adjusts the moving distance of the point image on the displayed image with respect to the moving distance of the image may be provided. In the feature, the moving distance of the point image corresponding to the moving distance of the directing position of the image indicating device can be adjusted. This function is possible since the moving distance of the point image can be set in accordance with various ways of moving the image indicating device so as to be suitable to the desire of the presenter.

The pointing device of the present invention can be understood as employing a method for displaying a point image. That is, the present invention provides a method for displaying a point image including: an image movement detecting step for detecting a movement of a photographed image; a calculating step for calculating a moving direction and a moving distance of a point image corresponding to the movement of the photographed image; and a signal generating step for generating a signal for synthesizing the point image with a displayed image based on the result of calculation in the calculating step.

According to the present invention, since the movement of the target indicated by the image indicating device is detected based on the movement of the image obtained by the photographing device of the image indicating device, the moving direction and the moving distance of the point image are calculated based on the result of the detection, the number of added devices can be reduced, and the structure thereof can be simplified. Since an image as a detected object is not restricted in particular, the point image can be controlled without directing the image indicating device to the screen. That is, according to the present invention, the number of devices can be reduced as much as possible, the structure can be simple, troublesome alignment is not required, and the point image can be controlled without directing the image indicating device at the screen.

The present invention provides a pointing device including: an image indicating device for operating a point image: a photographing device for photographing, which is provided in the image indicating device; an image movement detecting device for detecting a movement of a photographed image which is photographed by the photographing device within a photographed view; a calculating device for calculating a moving direction and a moving distance of a point image corresponding to the movement of the photographed image; and a signal generating device for generating a signal for synthesizing the point image with a displayed image, wherein the image movement detecting device selects one or more regions as monitor points which have a gradation difference exceeding a predetermined level among each location of the photographed image.

According to the present invention, the position of the point image displayed on a screen or a display can be controlled based on the directed position (or the directed direction) of the image indicating device. That is, a portion having a gradation difference exceeding a predetermined level among each location of the photographed image is selected as characteristic points (monitor points), the relative movement within the photographed view is tracked, so that the change of the directing direction of the image indicating device is detected, and the movement of the point image is controlled based on the result of the detection.

That is, in the case in which the image indicating device is moved, when the directing direction thereof is changed, relative movement of the image within the photographed view is generated. When the generated movement is detected, a place (for example, a contour line portion of a specified object) having a large gradation gradient within the photographed view is dynamically selected as the characteristic point. As a result, the movement of the characteristic point within the photographed view can be detected without error.

The direction in which the point image is moved can be determined by using the fact that the movement of the characteristic point within the photographed view is opposite to the direction in which the image indicating device is directed. On the other hand, the moving distance of the point image and the moving distance of the characteristic point within the photographed view are set to have a predetermined relationship therebetween, and the moving distance of the point image can be calculated.

In the above manner, a location having a large gradation gradient is set as the characteristic point, and the movement of the characteristic point is detected, so that the change in the directing direction of the image indicating device is detected, and the point image displayed on the screen can thereby be moved based on the detected result. That is, the image indicating device directed to an appropriate location is moved, so that the position of the displayed point image can be controlled by the manner of moving the image indicating device.

In the above method, since a photographed image of a specified article having a large gradation or a contour thereof is recognized as the characteristic point, the reliability of the image recognizing can be improved, and it is easy to recognize the movement of the photographed image. As a result, the action of the photographing device can have high accuracy and high reliability.

That is, in the pointing device of the present invention, it is desirable that the image movement detecting device select monitor points from an image photographed in first photographing, obtain a monitoring pattern of the monitor points selected from the image photographed in first photographing, search the monitoring pattern from an image photographed in second photographing performed after a predetermined period of time passes from the first photographing, detect the positional change of the monitoring pattern within the photographed view by comparing the coordinates of the obtained monitoring pattern and the coordinates of the searched monitoring pattern, and calculate the moving direction and the moving distance of the photographed image within the photographed view based on the result of detection of the positional change.

The point image is an indication mark (for example, an arrow) for a presentation, which indicates an image (for example, a diagram or a map) displayed on a screen. In general, a presentation is performed such that a presenter explains using a diagram while pointing to the diagram by moving the point image on the display screen.

In the pointing device of the present invention, a moving distance adjusting device adjusting the moving distance of the point image corresponding to the moving distance of the photographed image may be desirably provided. In the above feature, the moving distance of the point image on the display screen can be adjusted in accordance with the change degree of the direction in which the image indicating device is directed. That is, adjusting can be performed such that the point image is moved by a large distance when the image indicating device is moved only a little, and the point image is moved by a small distance when the image indicating device is moved by a large amount.

The pointing device of the present invention may be desirably equipped with a control signal generating device generating a control signal for controlling a graphical user interface operating device. The graphical user interface (GUI) is a user interface allowing use of many graphics for displaying information for users and many operations by the pointing device.

In the above feature, various application software can be operated by using the point image displayed on the screen in the same way as in the operation of common personal computers.

In the above feature, for example, a presentation in which various application software is used can be performed in combination of operating the GUI. For example, in the case in which a presentation is performed by displaying images directly downloaded from the internet, operations such as changing an image and opening a linked image can be performed by using the point image displayed on the screen.

The pointing device of the present invention can be understood as employing a pointing method. That is, the present invention provides a method for displaying a point image, including: an image movement detecting step for detecting a movement of a photographed image by a photographing device provided in an image indicating device; a calculating step for calculating a moving direction and a moving distance of a point image corresponding to the movement of the photographed image; and a signal generating step for generating a signal for synthesizing the point image with a displayed image based on the result of calculation in the calculating step, wherein the image movement detecting step includes a step of selecting one or more regions as monitor points which have a gradation difference exceeding a predetermined level among each location of the photographed image.

In the above method for displaying the point image, it is desirable that the image movement detecting step include steps of: selecting monitor points from a first photographed image photographed in first photographing; obtaining a monitoring pattern of the monitor points selected from the first photographed image photographed in first photographing; searching the monitoring pattern from a second photographed image photographed in second photographing performed after a predetermined period of time passes from the first photographing; detecting the positional change of the monitoring pattern within the photographed view by comparing the coordinates of the obtained monitoring pattern and the coordinates of the searched monitoring pattern; and calculating a moving direction and a moving distance of the photographed image within the photographed view based on the result of detection of the positional change.

According to the present invention, since the movement of the target indicated by the image indicating device is detected from the movement of the image obtained by the photographing device of the image indicating device, the moving direction and the moving distance of the point image are calculated based on the result of the detection, the number of added devices can be reduced, and the structure thereof can be simplified.

Since the image of the detected object is not restricted in particular, the point image can be controlled without directing the image indicating device at the screen. In this case, since the characteristic point is such that the contour of the photographed object facilitating being tracked is searched, the relative movement of the photographed image within the photographed view in accordance with the movement of the image indicating device is detected by monitoring the characteristic point, the operation is not restricted depending on the target to which the image indicating device is directed. Since the portion having a clear gradation difference which reliably allows tracking a movement is used, errors in the action can be avoided and the reliability of the action can be improved.

Therefore, according to the present invention, the number of devices can be reduced as much as possible, the structure can be simple, troublesome alignment is not required, and the point image can be controlled without directing the image indicating device at the screen.

The present invention provides a pointing device including: a photographing device for photographing; a point image control mode for detecting the change of the directing direction of the photographing device based on a moving distance and a moving direction of an image photographed by the photographing device within a photographed view and determining a position of a point image on a display screen in accordance with the result of the detected change; a photographed image display mode for displaying a photographed image by the photographing device on the display screen; and a mode selecting signal generating device for generating a signal for selecting either the point image control mode or the photographed image display mode.

The pointing device of the present invention can select the following two modes. The first mode may be a photographed image display mode in which a photographed image by the photographing device of the pointing device is displayed on a screen. In the photographed image display mode, for example, in a presentation, an arbitrary image photographed by a speaker (a presenter) can be projected and displayed on the screen.

The second mode may be a point image control mode in which the position of the point image displayed on the screen is controlled by controlling the directing direction of the photographing device. In the point image control mode, for example, a presentation can be performed by indicating a freely selected portion of the image displayed on the screen.

The point image may be an image displayed as an arrow or a mark on an arbitrary display screen, attracts attention, and is appropriately moved on the display screen so as to indicate a predetermined portion thereof.

By selecting the above two modes, for example, the following presentation can be performed. For example, in a method in which answers written by a student on a notebook are displayed on a screen in a lesson, in the case in which the photographed image display mode is selected, the notebook of the student is photographed, and the photographed image of the notebook is projected on the screen. Then, in the case in which the mode is switched to the point image control mode, the content of the notebook of the student can be indicated by the point image.

For example, in a presentation using an image which is projected and displayed on the screen, the pointing device in the hand of a speaker is set in the photographed image display mode, a material at hand is photographed, and the photographed image is projected on the screen. As a result, the image of the material can be presented to the audience. Then, the mode of the pointing device is switched to the point image control mode, so that explanations can be performed while the displayed image is indicated by the point image such as the arrow.

By using the above method, explanations and presentations in which photographed images of, for example, notebooks of students, materials except for image data prepared beforehand for displaying, or samples brought to the presentation place can be performed.

The pointing device may be desirably equipped with a static image signal generating device generating a signal for executing a static image processing in which a displayed image is processed to be static in the photographed image display mode.

For example, in the case in which the image photographing mode is selected and an image photographed by the photographing device of the pointing device is displayed on the display device such as a screen, when the pointing device is moved, the image projected and displayed thereon is moved in accordance with the movement of the pointing device. In the case in which the image is displayed for the audience, the image moves in accordance with the movement of the pointing device, and it is difficult for the audience to view the image. In this case, it is desirable that the photographed image be statically displayed.

When the above static image signal generating device is used, the image which is photographed, can be projected and displayed on the screen can be displayed statically at any desired time. As a result, the image photographed by the pointing device can be displayed so as to be easily viewed by the audience. By using the statically displayed image, a presentation in which the point image is used can be performed effectively.

The above method of using the pointing device can be used as a method in which a notebook of a specific student is photographed, the photographed image is displayed on the screen, and a lesson is progressed while the displayed image is presented to all students in a class. The above method of using the pointing device can be used as a method in which, for example, in a handicraft lesson, a work of a specific student is photographed, the photographed image of the work is displayed on the screen, and the displayed image is presented to the all students in the lesson.

The pointing device of the present invention may be desirably equipped with a display device displaying an image photographed by the photographing device. In the feature, the image can be displayed on the pointing device, and, for example, in a presentation, the image photographed by the speaker can be checked at hand.

The pointing device of the present invention may be desirably equipped with a moving distance adjusting device which adjusts a moving distance of the point image corresponding to the moving distance of the photographed image. In the feature, in accordance with the individual difference of the motion of the pointing device, the relationship between the movement of the pointing device and the movement of the point image can be adjusted. For example, adjusting can be arbitrarily performed such that the point image is moved by a large distance when the image indicating device is moved only a little, and the point image is moved by a small distance when the image indicating device is moved by a large amount.

The pointing device of the present invention may be desirably equipped with a control signal generating device which generates a control signal for controlling a graphical user interface operating device. In the feature, the GUI operation by using the point image can be operated in the same way as in the operation of common personal computers. By using this function, for example, presentations in which the web contents are used can be performed.

The present invention can be understood to be a program for executing the functions of the pointing device. That is, the present invention provides a program for a computer which controls so as to determine a position of a point image indicating a freely selected position on a display screen, including the steps of: selecting a photographed image mode or a point image control mode, the photographed image display mode for displaying an image photographed by the photographing device on the display screen, the point image control mode for detecting a change of a directing direction of a photographing device based on a moving distance and a moving direction of a photographed image by the photographing device within a photographed view and determining the position of the point image on the display screen in accordance with the result of the detected change; transmitting image data for displaying an image photographed by the photographing device on the display screen in a case in which the photographed image display mode is selected; and transmitting image data for controlling the position of the displayed point image in a case in which the point image control mode is selected.

According to the present invention, since the change of the position indicated by the pointing device can be detected by analyzing the arbitrary photographed image, the position of the point image can be controlled without directing the pointing device at the display screen such as the screen. In addition, one of the photographed image display mode for displaying the photographed image and the point image control mode for detecting change of the directing direction of the photographing device based on the moving distance and the moving direction of the photographed image and determining the position of the point image based on the result of the detection of the change, so that in the case in which presentations or lessons are performed by using the displayed image on the screen, the display operation of displaying the photographed image on the screen and the pointing operation of the point image can be appropriately selected in an easy manner.

### BRIEF DESCRIPTION OF THE DRAWINGS

FIG. 1 is a schematic diagram showing a presentation system in which a pointing device of the First Embodiment according to the present invention is used.

FIG. 2 is a block diagram showing a structure of an image indicating device of the First Embodiment according to the present invention.

FIG. 3 is a block diagram showing a structure of a point image control device of the First Embodiment according to the present invention.

FIG. 4 is a flow chart for explaining processing by an image indicating device of the First Embodiment according to the present invention.

FIG. 5 is a flow chart for explaining image analyzing processing of the First Embodiment according to the present invention.

FIGS. 6A and 6B are conceptual diagrams for explaining an image analyzing method of the First Embodiment according to the present invention.

FIG. 7 is a schematic diagram showing a presentation system in which a pointing device of the Second Embodiment according to the present invention is used.

FIG. 8 is a block diagram showing a structure of a point image control device of the Second Embodiment according to the present invention.

FIG. 9 is a flow chart explaining an image analyzing method of the Third Embodiment according to the present invention.

FIG. 10 is a flow chart for explaining an image analyzing method of the Third Embodiment according to the present invention.

FIG. 11 is a front view of a monitor point set condition of the Third Embodiment according to the present invention.

FIG. 12 is a schematic diagram showing a presentation system in which a pointing device of the Fifth Embodiment according to the present invention is used.

FIG. 13 is a block diagram showing a structure of an indicating and photographing device of the Fifth Embodiment according to the present invention.

FIG. 14 is a block diagram showing a structure of a point image control device of the Fifth Embodiment according to the present invention.

FIG. 15 is a flow chart showing one example of an action of the Fifth Embodiment according to the present invention.

FIG. 16 is a schematic diagram showing a presentation system in which a pointing device of the Sixth Embodiment according to the present invention is used.

FIG. 17 is a block diagram showing a structure of a point image control device of the Sixth Embodiment according to the present invention.

### DESCRIPTION OF THE PREFERRED EMBODIMENTS

Embodiments of the present invention will be described hereinafter with reference to the drawings.

### (1) First Embodiment

### (1-1) Structure of the First Embodiment

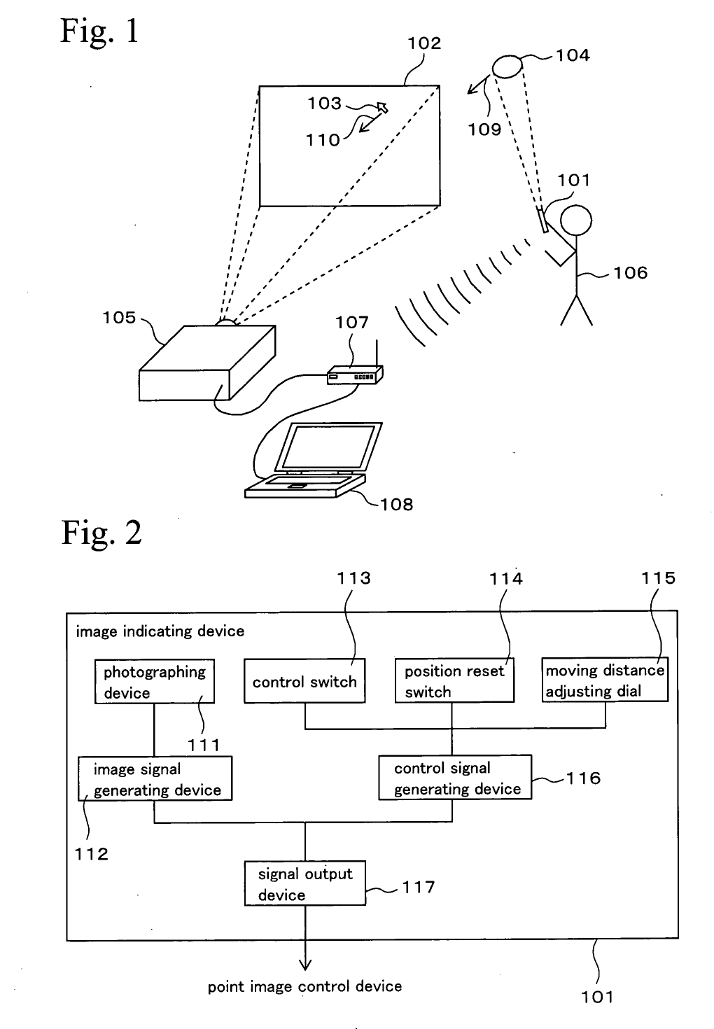

FIG. 1 is a conceptual diagram showing a presentation system having a pointing device of the First Embodiment according to the present invention. In FIG. 1, reference numeral 101 denotes an image indicating device, reference numeral 102 denotes a screen, reference numeral 103 denotes a point image, reference numeral 104 denotes a photographed object photographed by the image indicating device 101, and reference numeral 105 denotes a projecting device, reference numeral 106 denotes a presenter (a person performing a presentation), reference numeral 107 denotes a point image control device, and reference numeral 108 denotes a personal computer.

In the above presentation system, when the presenter 106 moves the image indicating device 101, the point image 103 projected onto the screen moves in accordance with the motion of the image indicating device 101. That is, the point image control device 107 analyzes the motion of the image indicating device 101 within a photographed view of an image photographed by the image indicating device 101, whereby the moving direction and the moving distance of the point image 103 are calculated, and the position of the displayed point image 107 is controlled in accordance with the calculated result.

The image indicating device 101 photographs an arbitrary photographed object set by the presenter 106, and transmits an image of the arbitrary photographed object to the point image control device 107. In addition, the image indicating device 101 transmits various control signals to the point image control device 107.

The personal computer 108 stores images made for presentations by using an appropriate application software, and transmits the image data to the point image control device 107 in accordance with predetermined operations.

The point image control device 107 generates a signal for controlling the position of the point image 103 on the screen 102 based on the signal transmitted from the image indicating device 101. In addition, the point image control device 107 synthesizes a point image with an image transmitted from the personal computer 108.

FIG. 2 is a block diagram showing an example of a structure of the image indicating device 101. The image indicating device 101 shown in FIG. 2 is equipped with a photographing device 111, an image signal generating device 112, a control switch 113, a position reset switch 114, a moving distance adjusting dial 115, a control signal generating device 116, and a signal output device 117.

The projecting device 105 is, for example, a liquid crystal projector or a three tube-type projector. The projecting device 105 projects an image onto the screen 102, based on the image data transmitted from the point image control device 107.

The photographing device 111 is a camera equipped with a charge coupled device. The image signal generating device 112 converts image data obtained by the photographing device 111 to appropriate electrical signals (image signals) for transmitting. The control switch 113 is used, for example, for switching to a mode in which a photographed image is directly projected and for using a mouse function, described below. For example, the control switch can 113 has a function corresponding to a right click operation and a left click operation of a mouse. The position reset switch 114 is a switch for initializing a position of the point image 103. For example, the point image 103 can be forcibly displayed at a center of the screen 102 by operating the position reset switch 114.

The moving distance adjusting dial 115 is a dial for adjusting the relationship between a directing direction or a directing position of the image indicating device 101 and a moving distance of the point image 103 on the screen. For example, in the case in which the moving distance of the point image 103 on the screen is adjusted so as to be greately changed in comparison with the moving distance of the directing position of the image indicating device 101, when the image indicating device 101 is moved a little, the point image 103 can be moved by a large amount.

The control signal generating device 116 converts operation contents of the control switch 113, the position rest switch 114, and the moving distance adjusting dial 115 to appropriate signals for transmitting the above operation contents to the point image control device 107. The signal output device 117 transmits electrical signals as electric waves, which are generated by the image signal generating device 112 and the control signal generating device 116, to the point image control device 107.

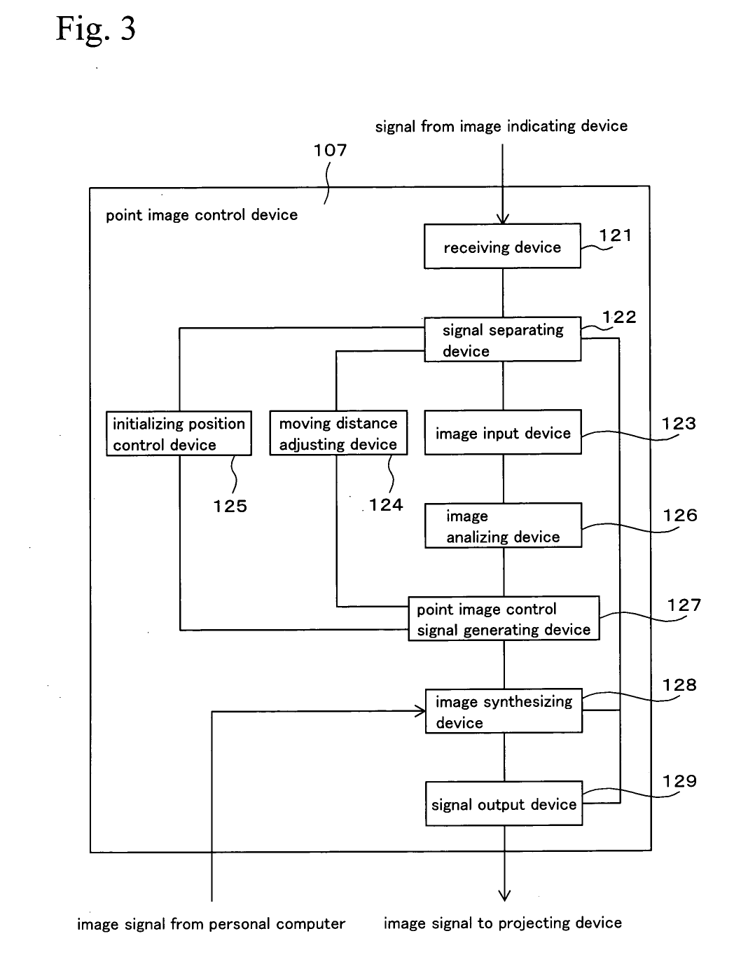

FIG. 3 is a block diagram showing an example of a structure of the point image control device 107 shown in FIG. 1. The point image control device 107 as shown in FIG. 3 is equipped with a receiving device 121, a signal separating device 122, an image input device 123, a moving distance adjusting device 124, an initializing position control device 125, an image analyzing device 126, a point image control signal generating device 127, an image synthesizing device 128, and a signal output device 129.

The receiving device 121 receives electrical waves from the image indicating device 101. The signal separating device 122 separates an image signal and various control signals from the signals received by the receiving device, and transmits these separated signals to predetermined devices. The moving distance adjusting device 124 receives a control signal reflecting the adjusting contents of the moving distance adjusting dial 115 of the image indicating device 101 and adjusts a ratio of the moving distance of the point image 103. For example, the moving distance adjusting device 124 changes a ratio of the moving distance of the point image 103 to the moving distance of the image photographed by the image indicating device 101 based on a predetermined reference value. The ratio is changed by the set condition of the moving distance adjusting dial 115 shown in FIG. 2.

The image input device 123 inputs images, which are photographed by the photographing device 111 shown in FIG. 2, thereinto. The image analyzing device 126 analyzes the image input into the image input device 123 (the image photographed by the photographing device 111), and calculates the moving direction and the moving distance of the above image within a photographed view. The detail of the image analyzing method is described below.

The point image control signal generating device 127 calculates a moving direction and a moving distance of the point image 103 based on the above calculated moving direction and the above calculated moving distance of the image within the photographed view, and generates coordinate data of the position at which the point image is displayed, based on the calculated result.

The point image control signal generating device 127 processes such that the moving distance of the point image 103 is set at the value in accordance with the operation of the moving distance adjusting dial 115 shown in FIG. 2, based on the signal from the moving distance adjusting device 124. The point image control signal generating device 127 processes such that the point image 103 is displayed at a predetermined position on the screen 102 when receiving the signal such that the point image 103 is forcibly displayed at a predetermined position from the initializing position control device 125.

The image synthesizing device 128 generates image data for displaying a point image at the position determined by the coordinate data generated by the point image control signal generating device 127, synthesizes the image data with the image transmitted from the personal computer 108 shown in FIG. 1. As a result, a synthesized image is generated such that the point image is synthesized with the image transmitted from the personal computer 108 at the predetermined position.

The signal output device 129 transmits image signals processed by the image synthesizing device 128 to the projecting device 105 shown in FIG. 1. The signal output device 129 transmits separated image data by the signal separating device 122 to the projecting device 105.

In the First Embodiment, an optical zoom function of the projecting device 105 may be operated by the image indicating device 101. In this case, the image indicating device 101 is further equipped with a zoom adjusting operation switch, and the point image control device 107 is further equipped with a zoom adjusting signal generating device. In this structure, the zoom adjusting operating switch of the image indicating device 101 is operated, a signal reflected by the operation of the zoom adjusting operating switch is transmitted to the point image control device 107, a control signal for controlling the optical zoom function of the projecting device 105 is generated by the zoom adjusting signal generating device of the point image control device 107 in accordance with the received signal reflected by the operation of the zoom adjusting operating switch, and the optical zoom function of the projecting device 105 is controlled by the control signal generated by the zoom adjusting signal generating device.

### (1-2) Action of the First Embodiment

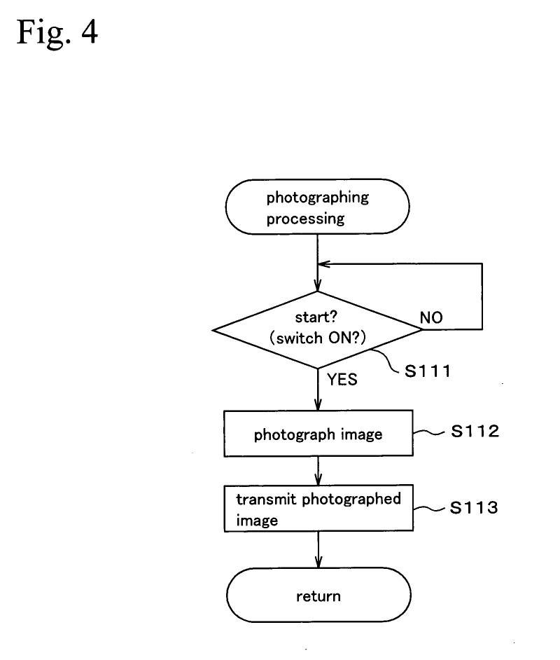

First, one example of the action of the image indicating device 101 will be described hereinafter. FIG. 4 is a flow chart showing one example of the action of the image indicating device 101. First, it is determined whether or not use of the image indicating device 101 is started, that is, whether or not the photographing start switch is set ON (in step S111). When the photographing start switch is set ON, the photographing device 111 shown in FIG. 2 takes a photograph (in step S112). When the photographing start switch is not set ON, the step S111 is repeatedly executed.

An image photographed by the photographing device 111 shown in FIG. 2 is converted to an image signal by the image signal generating device 112, and is transmitted as an electronic signal from the signal output device 117 to the point image control device 107 shown in FIG. 1 (in step S113).

The above processing is repeatedly executed in the use of the image indicating device 101. Then, the image signal of the photographed object 104 obtained by the photographing device 111 of the image indicating device 101 is sequently transmitted to the point image control device 107.

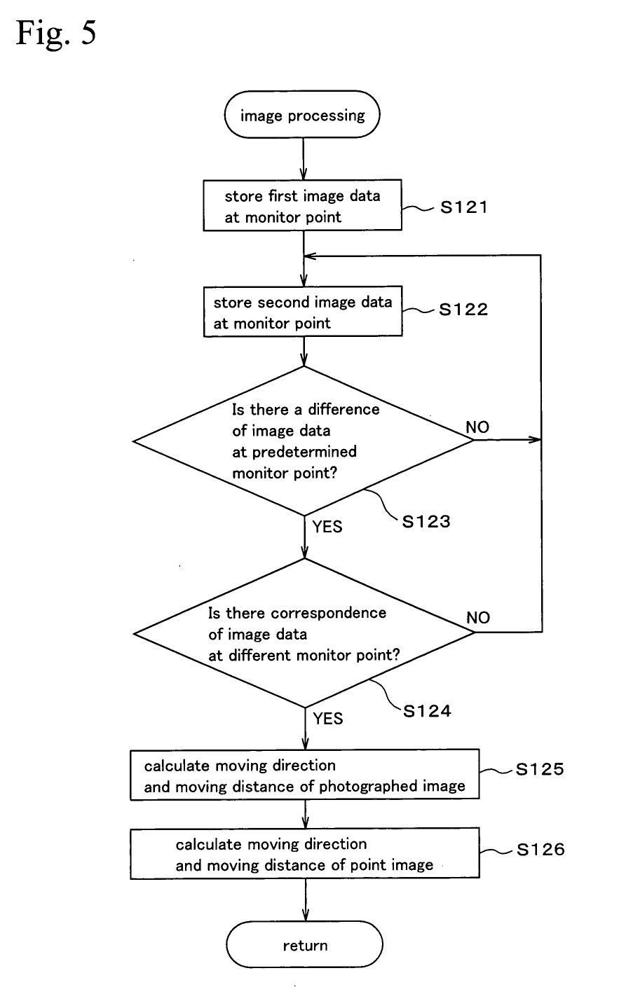

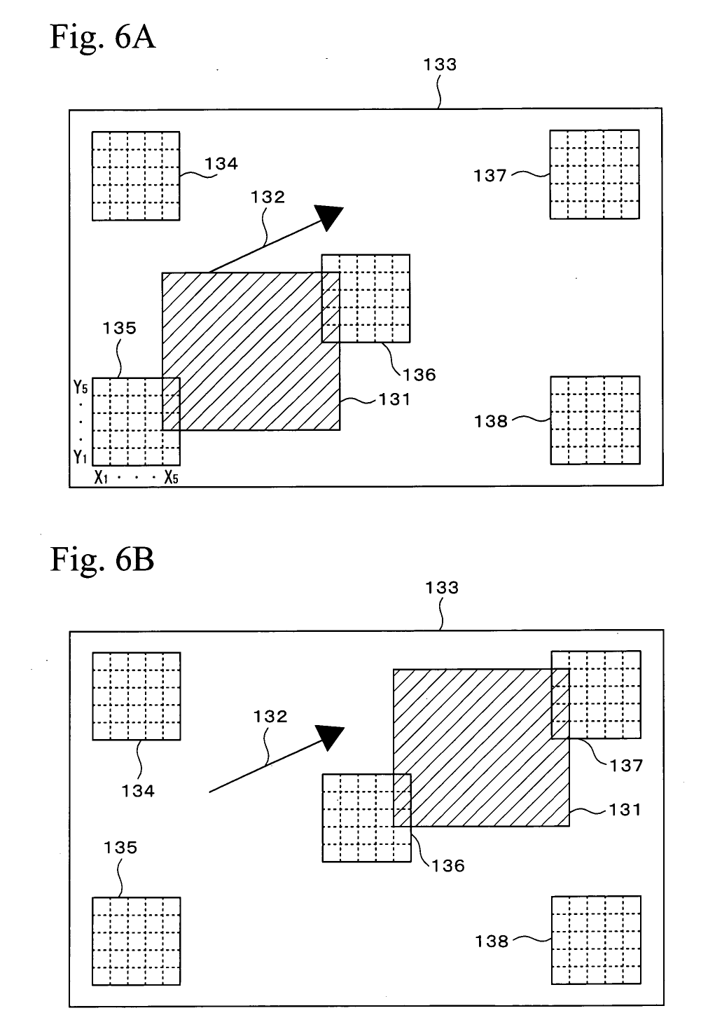

Next, one example of the point image control device 107 will be described hereinafter. FIG. 5 is a flow chart showing one example of image processing by the image analyzing device 126 and the point image control signal generating device 127 shown in FIG. 3. FIGS. 6A and 6B are conceptual diagrams for explaining one example of the image analyzing method. In FIGS. 6A and 6B, an image view 133 photographed by the image photographing device 101 shown in FIG. 1 is shown. The photographed view 133 corresponds to the photographed object 104 shown in FIG. 1. FIGS. 6A and 6B show one example in which in accordance with a movement of the indicating direction by the image indicating device 101 operated by the presenter 106, a specific image 131 within the photographed view 133 moves in a direction shown by an arrow 132 from a position shown in FIG. 6A to a position shown in FIG. 6B.

FIGS. 6A and 6B show a case in which five monitor points 134 to 138 are provided within the photographed view 133. The five monitor points 134 to 138 are used for sensing a movement of a photographed image in the photographed view 133. That is, the photographed image is partially divided into five sections by the five monitor points 134, and the movement of the photographed image obtained by the photographing device of the image indicating device 101 is sensed by comparing the divided image data at time intervals.

The monitor points 134 to 138 are divided into grid-like Xm×Yn dots (pixels). FIGS. 6A and 6B show one example in which the monitor points 134 to 138 are divided into matrixes of 5×5 pixels. The photographed image is divided into five portions by the monitor points 134 to 138. The reference symbols m and n denote natural number except for zero.

The portions of the photographed image divided at the above respective monitor points are shown by table data stored in memory regions of (Xm, Yn). The table data is data for specifying the image at each monitor point.

For example, in the example shown in FIGS. 6A and 6B, in a case of a black and white image, image data at each monitor point 134 to 138 is shown as 5×5 table data storing pixel data of 0 or 1.

The monitor points 134 to 138 are used for sensing the movement of the photographed image and calculating the moving direction and the moving distance thereof. As described below, the moving direction and the moving distance are calculated by analyzing the temporal change of the image data at the five monitor points. In the above method in which the monitor points are set, since it is unnecessary to use image data of the overall image, analyzing processing time can be shortened, and hardware and software program for analyzing can be simplified. The monitor setting method is not limited to the example shown in FIGS. 6A and 6B, and various numbers of setting position and various setting positions can be used.

One example of processing for sensing the movement of the photographed image by using the monitor points 134 to 138 will be explained. Image processing described below is executed in the image analyzing device 126 and the point image signal generating device 127 shown in FIG. 3.

First, image data (first image data) at the monitor points 134 to 138 at a predetermined point in time is stored (in step of S121). The image data is stored in a memory (not shown) in the image analyzing device 126.

Storing the image data is repeatedly performed based on a predetermined sampling frequency. Therefore, when a predetermined period of time passes from the execution of the step S121, image data (second image data) at the monitor points 134 to 138 are stored (in step of S122).

Next, it is determined whether or not there is difference of pixel data at a predetermined monitor point based on comparison of the first image data and the second image data (in step S123). In the step S123, the first image data and the second image data at each monitor point are compared. That is, the first image data and the second image data at the monitor point 134 are compared, the first image data and the second image data at the monitor point 135 are compared, and the first image data and the second image data at the monitor point 136 are compared.

When at least one difference exists between the first image data and the second image data at each monitor point, the precessing goes to step S124. When no difference exists between the first image data and the second image data at each monitor point, the processing returns to the step S122. For example, when the presenter shown in FIG. 1 does not move the image indicating device 101, the photographed image does not move, and the first image data and the second image data are equal at each monitor point. As a result, the determination in the step S123 is NO, and the processing after the step S122 is repeatedly executed.

In the step S124, it is determined whether or not pixel data at the different monitor points correspond with each other. That is, it is determined whether or not the first image data at one monitor point or the second image data at another monitor point correspond with each other. This determination is performed at every monitor point. For example, the processing is executed at each monitor point such that the first image data at the monitor point 134 and the second image data at the monitor points 135 to 138 are compared with each other, it is determined whether or not corresponding data exists thereamong, the first image data at the monitor point 135 and the second image data at the monitor points 134 and 136 to 138 are compared with each other, and it is determined whether or not corresponding data exists thereamong.

Then, when corresponding data exists among the image data at different monitor points, the processing goes to step S125. When corresponding data exists among the image data at different monitor points, the processing returns to the step S122.

In the step S125, the moving direction and the moving distance of the photographed image are calculated based on the positions of the two monitor points corresponding with each other. Then, in the point image control signal generating device 127 shown in FIG. 3, a moving direction and a moving distance of a point image are calculated based on the moving direction and the moving distance of the photographed image calculated in the step S125 (in step S126). The above processing is repeatedly executed, and the position of the point image is controlled in accordance with the movement of the photographed image.

One concrete example of the position control of the point image will be described hereinafter. FIGS. 6A and 6B show one example in which the specific image 131 moves from the position shown in FIG. 6A to the position shown in FIG. 6B. It is assumed that the first image data is stored in the state shown in FIG. 6A (in the step S121), and the second image data is stored in the state shown in FIG. 6B (in the step S122).

In this case, the image data at the monitor point 135 in FIG. 6A and the image data at the monitor point 135 in FIG. 6B are different from each other. The image data at the monitor point 136 in FIG. 6A and the image data at the monitor point 136 in FIG. 6B are different from each other. The image data at the monitor point 137 in FIG. 6A and the image data at the monitor point 137 in FIG. 6B are different from each other. Therefore, the determination in the step S123 is YES.

Then, the image data at the monitor point 135 in FIG. 6A and the image data at the monitor point 136 in FIG. 6B correspond with each other. The image data at the monitor point 136 in FIG. 6A and the image data at the monitor point 137 in FIG. 6B correspond with each other. That is, the first image data and the second image data correspond with each other at different monitor points. Therefore, the determination in the step S124 is YES.

Then, the movement, which is shown as the arrow 132, from the position of the specific image 131 shown in FIG. 6A to the position of the specific image 131 shown in FIG. 6B is calculated based on the position relationship of the monitor points of which image data correspond with each other. That is, the moving direction and the moving distance of the specific image 131 are calculated. Since the specific image 131 is a portion of the photographed image, the moving direction and the moving distance of the photographed image are calculated by calculating the moving direction and the moving distance of the specific image 131. In the above manner, the moving direction and the moving distance of the photographed image are calculated by the image analyzing device 126 shown in FIG. 3.

As shown in FIGS. 6A and 6B, in the case in which the photographed image moves in a direction of the arrow 132, in the image indicating device 101 the directing direction thereof is moved in a direction opposite to the direction of the arrow 132. For example, in the case in which the direction of the image indicating direction 101 is moved so that the photographed object 104 moves in the direction of the arrow 109 shown in FIG. 1, the photographed image photographed by the photographing device 111 moves in the direction of the arrow 132 shown in FIGS. 6A and 6B, which has a difference of 180 degrees from the arrow 109. By using the above relationship, in the point image control signal generating device 127 shown in FIG. 3, the processing of the step S126 is executed, so that the moving direction 110 and the moving distance of the point image 103 shown in FIG. 1 are calculated. Based on this calculated result, a signal for determining a display position of a point image is generated, and in the image synthesizing device 128 a point image is synthesized at predetermined coordinates transmitted from the personal computer 108.

In the above manner, the presenter shifts the direction of the image indicating device 101, and the directing direction thereof moves in the direction of the arrow 109, so that the photographed image by the photographing device 111 moves in the direction of the arrow 132 shown in FIGS. 6A and 6B. The moving direction and the moving distance of the photographed image are calculated based on comparison among the image data of the monitor points 134 to 138, the moving direction and the moving distance of the point image are calculated based on the calculated result, and the display position of the point image 103 shown by the arrow 110 is controlled.

In the above method in which the movement of the photographed image is sensed by using the monitor points 135 to 138, the used data amount can be small, so that the calculating speed can be large, and the response characteristic can be good. As a result, the presenter can perform a presentation, in which the point image 103 is used, without stress. Since the used data amount can be small and the calculating can be easily performed, the required hardware can be simplified, low cost can be realized, the good reliability can be obtained.

As the method for analyzing the image photographed by the image indicating device 101 and sensing the change of the direction directed by the image indicating device 101 (or the change of the directing position thereof), a method can be used in which, a specified image is caught by sensing a characteristic (for example, a change point of brightness or color tone of an edge) of a photographed image, and a movement of the image within a view is sensed.

In the First Embodiment, the moving distance of the point image can be adjusted by the moving distance adjusting device 124 shown in FIG. 3. The change of the directing position of the image indicating device 101 and the moving distance of the point image 103, corresponding to the swinging angle thereof, on the screen 102 can be arbitrarily adjusted.

The above adjustment is performed by operating the moving distance adjusting dial 115 of the image indicating device 101 shown in FIG. 2. That is, when the moving distance adjusting dial 115 is adjusted, a signal reflecting the adjusted content is generated by the control signal generating device 116, and is transmitted from the image indicating device 101 to the point image control device 107. This control signal is transmitted from the signal separating device 122 to the moving distance adjusting device 124 via the receiving device 121. In the moving distance adjusting device 124, the moving distance of the point image 103 is set in accordance with the operated state of the moving distance adjusting dial 115, and a signal for determining the set content of the moving distance of the point image 103 is transmitted to the point image control signal generating device 127.

In the above feature, the moving distance of the point image 103 on the screen 102 corresponding to the moving distance of the photographed object 104 of the image indicating device 101 can be adjusted based on the habits or the individual variation of moving the image indicating device 101 by the presenter 106 shown in FIG. 1.

In the First Embodiment, the position of the point image 103 on the screen 102 can be forcibly aligned in a predetermined timing. For example, the position of the point image 103 on the screen 102 can be forcibly displayed at a center of the screen.

One detailed example of the above action will be explained hereinafter. When the presenter 106 shown in FIG. 1 operates the position reset switch 114 shown in FIG. 2, a signal for instructing based on the above operation is generated by the control signal generating device 116, is received by the receiving device 121 of the point image control device 107 shown in FIGS. 1 and 3, and is transmitted to the initializing position control device 125 via the signal separating device 122. A signal for displaying the point image 103 at a predetermined position on the screen (for example, a center of the screen 102) is transmitted to the point image control signal generating device 127 by the initializing position control device 125 receiving the signal for instructing based on the above operation. In the point image control signal generating device 127, a signal for displaying the point image at the predetermined position on the screen 102 is generated and is transmitted to the image synthesizing device 128. Then, in the image synthesizing device 128, a synthesized image is made such that the point image 103 is displayed at the center of an image transmitted from the personal computer, and the synthesized image data is transmitted to the projecting device 105. The synthesized image is projected by the projecting device 105 onto the screen 102. In the above manner, the point image 103 is forcibly displayed at the center of the screen 102.

In the above feature, the presenter 106 shown in FIG. 1 can initialize or reset the position of the point image 103 on the screen 102 in an arbitrary timing. The presenter 106 can perform reset operation for re-displaying the point image at a predetermined position when the point image 103 is missing by using the above function. The reset operation can be used for setting an initial position of the point image 103 when starting a presentation.

In the structure shown in FIG. 1, an image photographed by the image indicating device 101 can be projected onto the screen. In this case, the image indicating device 101 in FIG. 2 is switched to the image photographing mode by operating the control switch 113. Then, in the image signal generating device 112 the image photographed by the photographing device 111 is converted to an image signal, and is transmitted from the signal output device 117 to the point image control device 107 shown in FIG. 1. In the point image control device 107 shown in FIG. 3, the image signal is received by the receiving device 121, and is transmitted to the projecting device 105 shown in FIG. 1 via the signal separating device 122 and the signal output device 129. An image photographed by the image indicating device 101 is projected from the projecting device 105 onto the screen 102. In the above feature, in the presentation, it is possible to project a photographed image of a sample onto the screen.

The image photographed by the image indicating device 101 can be synthesized with the image transmitted from the personal computer 108, and the synthesized image can be projected onto the screen 102. In this case, the image data from the image indicating device 101 is received by the receiving device 121 of the point image control device 107, and is transmitted from the signal separating device 122 to the image synthesizing device 128, and the image synthesizing is performed thereby.

### (2) Second Embodiment

### (2-1) Structure of the Second Embodiment

In the Second Embodiment, a graphical user interface (GUI) function of a personal computer is combined with the position control technique of the point image of the First Embodiment according to the present invention. The GUI is a user interface such that substantial graphics for displaying the information for user are used, and operations of application software can be performed by a pointing device such as a mouse.

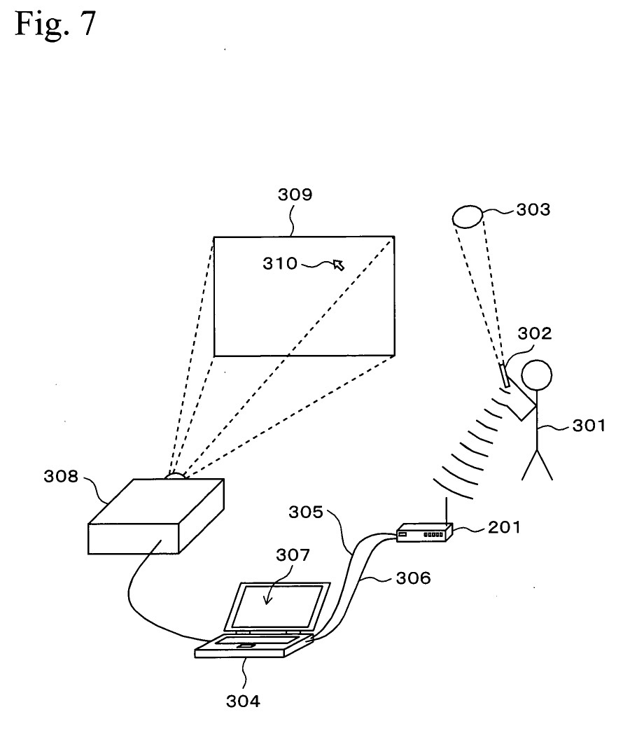

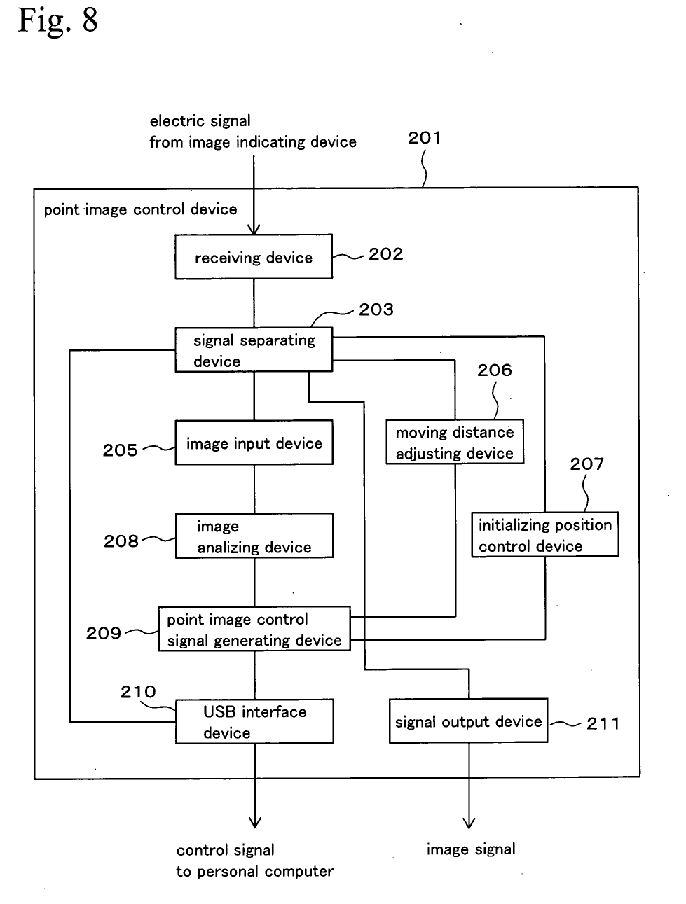

FIG. 7 is a conceptual diagram showing another presentation system in which the pointing device of the present invention is used. FIG. 8 is a block diagram showing one example of a structure of a point image control device 201 shown in FIG. 7.

The Second Embodiment is an example in which the present invention is applied to a system in which a point image is projected and is displayed on a screen by using a control function of a point image (mouse pointer) of a common personal computer.

In FIG. 7, reference numeral 301 denotes a presenter, reference numeral 302 denotes an image indicating device, reference numeral 303 denotes a photographed object photographed by the image indicating device 302, reference numeral 201 denotes a point image control device, reference numeral 304 denotes a personal computer, reference numeral 305 denotes a USB (Universal Serial Bus) cable, reference numeral 306 denotes an image transmission cable, reference numeral 307 denotes a display of the personal computer 304, reference numeral 308 denotes a projecting device, reference numeral 309 denotes a screen, and reference numeral 310 denotes a point image.

In the Second Embodiment, an image photographed by the image control device 302 is analyzed in the point image control device 201, so that a moving direction and a moving distance of a photographed object of the image indicating device 302 are calculated. Then, in the point image control device 201, a USB Standards signal for instructing a display position of the point image 310 is generated based on the analyzed result, and is transmitted to the personal computer 304. In the personal computer 304, an image on which the point image is positioned at predetermined coordinates thereof is generated by using a display position control function of a point image of the GUI, is transmitted to the projecting device, and is projected onto the screen 309 by the projecting device 308. In the above manner, the point image 310 can be displayed on the screen 309 while following the movement of the image indicating device 302.

In the above feature, the position control of the point image 310 is performed by using a control function of a point image (mouse pointer) of a common personal computer. In this point, the Second Embodiment is different from the First Embodiment in which the point image is synthesized by the external device with the image generated by the personal computer. In the Second Embodiment, it is possible to operate the GUI function using the point image since the point image control function of the personal computer is used.

In the Second Embodiment, the image indicating device 302 is equipped with plural control switches 113 in the structure shown in FIG. 2, and switches corresponding to right click switch and a left click switch of a common mouse are contained therein.

A signal which is output from the point image control device 201 and is input into a USB input port of the personal computer is the same as a signal input from a common pointing device (for example, a mouse) to a personal computer. The processing of the personal computer for position control is the same as a common pointing device. Therefore, it is possible to perform processing by the same right click operation and left click operation as a common mouse by using the image indicating device 302. That is, it is possible to operate the GUI by using the image indicating device 302.

In the Second Embodiment, as shown in FIG. 8, the point image control device 201 shown in FIG. 201 is equipped with a receiving device 202, a signal separating device 203, an image input device 205, a moving distance adjusting device 206, an initializing position control device 207, an image analyzing device 208, a point image control signal generating device 209, a USB interface device 210, and a signal output device 211.

In FIG. 8, since the devices other than the USB interface device 210 have the same functions as the devices shown in FIG. 3, explanations of the devices other than the USB interface device 210 are omitted. The USB interface device 210 has a function for generating a signal of USB Standards for instructing a position of a point image based on the generated signal by the point image control signal generating device 209 and for transmitting the generated signal of USB Standards to the personal computer 304 shown in FIG. 7. The USB interface device 210 has a function for converting a right click operation signal and a left click operation signal, in which the point image is used, to a signal of USB Standards and for transmitting the converted signal to the personal computer 304 shown in FIG. 7.

### (2-2) Action of the Second Embodiment

In FIG. 7, when the presenter 301 moves the image indicating device 302 so as to change the directing direction thereof, the photographed object 303 is moved relatively, and the image within the photographing view is moved. The image data containing the information of the movement of the image within the photographing view is transmitted from the image indicating device 302 to the point image control device 201. In the point image control device 201, the image data is received by the receiving device 202, and is transmitted to the image input device 205 via the signal separating device 203. The image data input into the image input device 205 is analyzed by the image analyzing device 208, so that the movement of the above image within the photographing view is analyzed. Based on the analyzed result, the moving direction and the moving distance of the image photographed by the photographing device 111 shown in FIG. 2 are calculated. The analyzing method is the same as that of the First Embodiment.

In the point image control signal generating device 209, based on the analyzed result by the image analyzing device 208, the moving direction and the moving distance of the point image is calculated, and the coordinates of the point image are calculated based on the calculated result. The processing of the point image control signal generating device 209 is the same as that of the First Embodiment. In the USB interface device 210, the coordinate data of the point image output from the point image control signal generating device 209 are converted to a signal of USB Standards, and are transmitted to the USB port of the personal computer 304 via the USB cable 305.

In the personal computer 304, based on the signal for instructing a display position of the point image, transmitted from the point image control device 201, the point image is synthesized with a presentation image. This processing is the same as that for a signal transmitted from a common pointing device (for example, a mouse). The image generated by the personal computer 304 containing the point image is transmitted to the projecting device 308, and is projected from the projecting device 308 to the screen 309. In the above manner, the position of the point image displayed on the screen 309 can be controlled by changing the directing position of the image indicating device 302.

In the Second Embodiment, by using the point image 310, the processing by using the GUI can be performed on the screen 309. For example, an image generated by application software allowing the GUI to be used is displayed on the screen 309. In this case, as described above, the position of the point image 310 on the screen can be operated by the directing position of the image indicating device 302. By operating the control switch 113 of the image indicating device 302 shown in FIG. 2, operations corresponding to right click and left click of a mouse performed in common personal computer operations can be performed on an image displayed on the screen 309.

For example, the control switch 113 of the image indicating device 302 shown in FIG. 2 is operated, and the operation corresponding to the left click is performed. In this case, a signal having the information of the left click is generated by the control signal generating device 116, and is transmitted from the signal output device 117 to the point image control device 201 shown in FIG. 8. The signal is received by the receiving device 202 of the point image control device 201, and is transmitted from the signal separating device 203 to the USB interface device 210. Then, the signal is converted to a signal of USB Standards, and is transmitted to the personal computer 304 shown in FIG. 7. In the personal computer 304, the same processing as that of the common mouse operation is performed, and the left click operation by using the point image is performed.

In the above manner, in the system shown in FIG. 7, the operation of the GUI by using the point image 310 is performed by using the image indicating device 302.

In the Second Embodiment shown in FIG. 7, the image photographed by the image indicating device 302 can be directly projected onto the screen 309. In this case, the image data of the image photographed by the photographing device of the image indicating device 302 is received by the receiving device 202 of the point image control device 201 shown in FIG. 8, and is transmitted from the signal separating device 203 to the signal output device 211. The image signal is transmitted by the signal output device 211 to the personal computer via the image transmission cable 306. The image signal is processed by using appropriate application software by the personal computer, and is transmitted to the projecting device 303. The image is projected onto the screen 309.

The switching to a mode in which the image photographed by the image indicating device 302 is projected onto the screen 309 may be performed by using the control switch 113 shown in FIG. 2.

In the Second Embodiment shown in FIG. 7, the moving distance of the point image 310 can be adjusted in accordance with the change of the directing direction of the image indicating device 302 or the moving directing position thereof. In this case, in the moving distance adjusting device 206 of the point image control device 201 shown in FIG. 8, based on the operation of the moving distance adjusting dial 115 shown in FIG. 2, a signal for setting the moving distance of the point image is generated, and in the point image control signal generating device 209 the processing is performed such that the position of the point image is reflected on the adjusted moving distance.

In the Second Embodiment shown in FIG. 7, the point image 310 can be forcibly re-displayed at a predetermined position. In this case, by operating the position reset switch 114 shown in FIG. 2, in the initializing position control device 207 of the point image indicating device 201 shown in FIG. 8, a signal for forcibly displaying the point image at a predetermined position is generated, and in the point image control signal generating device 209, the processing is performed such that the point image is forcibly displayed at a predetermined position on the image projected onto the screen 309.

Although in the above examples the case in which the image is projected onto the screen by using the projecting device and the point image is displayed on the projected image is explained, a cathode ray tube, a liquid crystal display, a plasma display, or a display device with an appropriate light emitting device may be used as the display device for displaying the image. The present invention is not limited to presentations, and can be applied to various processing, operations, games in which images are used, and representation activities.

In the above-described examples, the image indicating device is equipped with the signal output device for outputting a signal for displaying the photographed image on the display image, and the image directly photographed by the image indicating device can be input into the personal computer, or can be displayed as the display image. In this function, for example, in a presentation, a sample is photographed by the camera of the image indicating device, and the photographed image is projected onto the screen, so that the presentation effects can be improved.

The present invention can be applied to the operation of the point image displayed on the screen. For example, the present invention can be applied to devices for performing presentations by operating a point image projected onto a screen and techniques related thereto.

### (3) Third Embodiment

In the Third Embodiment of the present invention, the same components as in the First Embodiment are given the same numeral references, and the description of the structures and the actions thereof are omitted.

### (3-1) Structure of Third Embodiment

The structure of the Third Embodiment of the present invention is the same as in the First Embodiment.

The action of the Third Embodiment of the present invention is different from that of the First Embodiment in the method for the position control of the point image 103. That is, in the Third Embodiment, the image processing executed by the image analyzing device 126 and the point image control signal generating device 127 is different from that in the First Embodiment.

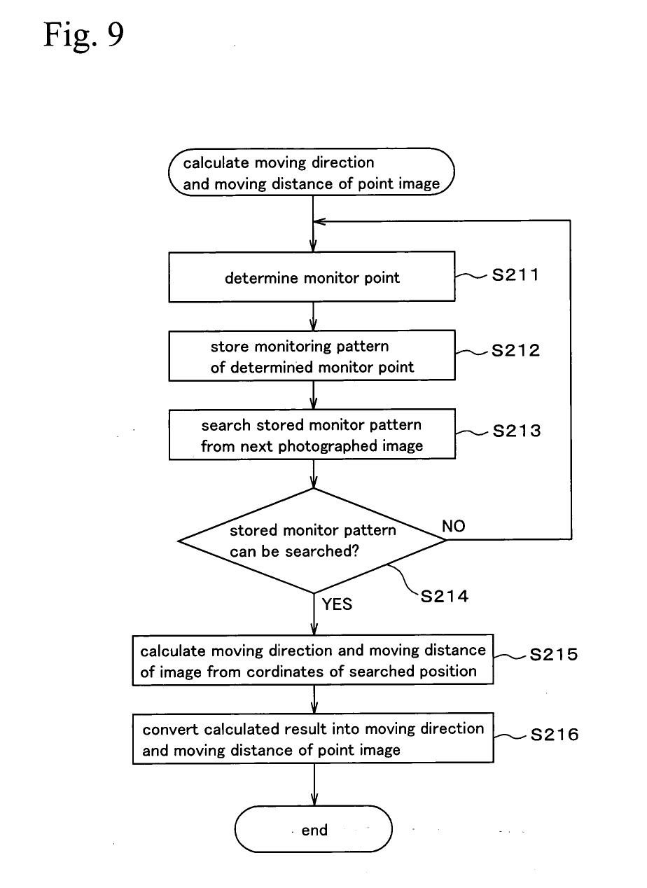

The details of one example of the position control of the point image 103 of the Third Embodiment will be described hereinafter. FIG. 9 is a flow chart showing one example of the image processing executed by the image analyzing device 126 and the point image control signal generating device 127.

The image analyzing device 126 determines monitor points for obtaining basic data for sensing a motion of an image, which is transmitted from the photographing device 111, within a photographing view (in step S211). The details of the processing for determining monitor points will be described hereinafter.

When the monitor points are determined, the image analyzing device 126 stores coordinate data of the monitor points and monitoring pattern data at monitor points. Since the monitor points are, for example, m×n pixel matrixes, the monitoring pattern is obtained as table data of the matrix pixels. For example, in the case in which a black and white image is used and the monitor point is a pixel matrix having 10×10 pixels, table data having data of “1” as a white portion and data of “0” as a black portion which are arranged in a 10×10 matrix is obtained.

When the monitoring pattern is stored, the image analyzing device 126 searches the data corresponding to the stored monitoring pattern in the step S212 from the image data input into the image input device 123 at predetermined intervals (in step S213).

When the search in the step S213 cannot be performed, the image analyzing device 126 returns to the step S211, and executes the processing after the step S211 again. In the case in which the search in the step S213 can be performed, the image analyzing device 126 progresses to step S215.

In the step S215, the image analyzing device 126 compares the searched coordinate data of the monitoring pattern with the stored coordinate data of the monitor points stored in the step S212. Based on the compared result, a relative motion of the image photographed by the photographing device 111 within the photographed view is calculated.

When the moving direction and the moving distance of the photographed image within the photographed view are calculated in the step S215, the moving direction and the moving distance of the point image is calculated based on the calculated result (in step S216). In the above manner, the moving direction and the moving distance of the point image, which correspond to the change in the directing direction of the image indicating device 101, are calculated.

For example, the directing direction of the image indicating device 101 are not moved, the searched coordinate data of the monitoring pattern is the same as the stored coordinate data of the monitor points stored in the step S212. Therefore, in the calculated result in the step S216, the moving direction of the point image is not changed, and the moving direction of the point image is 0. As a result, the processing is executed such that the point image shown in FIG. 1 is not moved.

On the other hand, for example, the image indicating device 101 is moved, and the position of the directing direction thereof shown in FIG. 1 is moved in the direction shown by the arrow 109. In this case, the image within the photographed view of the photographing device 111 moves in a direction 180 degrees different from the arrow 109 shown in FIG. 1, and the selected monitor point is moved within the photographed view in the same manner as the image. Therefore, the image of the monitoring pattern searched in the step S213 is moved to the upper right side with respect to the position as it was. By comparing the coordinates of the image of the moved monitoring pattern with the coordinates of the monitor point selected in the step S211, the moving direction and the moving distance of image of the monitoring pattern within the photographed view are calculated. For example, in this case, a predetermined moving distance to the upper right side is calculated.

Then, in the step S216, the moving direction calculated in the step S215 is converted to a direction opposite thereto, so that the moving direction of the point image 103 on the screen 102 is calculated, and the moving distance of the image of the monitoring pattern within the photographed view, which is calculated in the step S215 is converted to the moving distance of the point image 103 on the screen 102.

The above corresponding relationship can be adjusted as described below. For example, in the case in which the directing direction of the image indicating device 101 is moved a little, the set in which the point image 103 moves much or moves a little corresponding to the movement of the image indicating device 101 is adjustable.

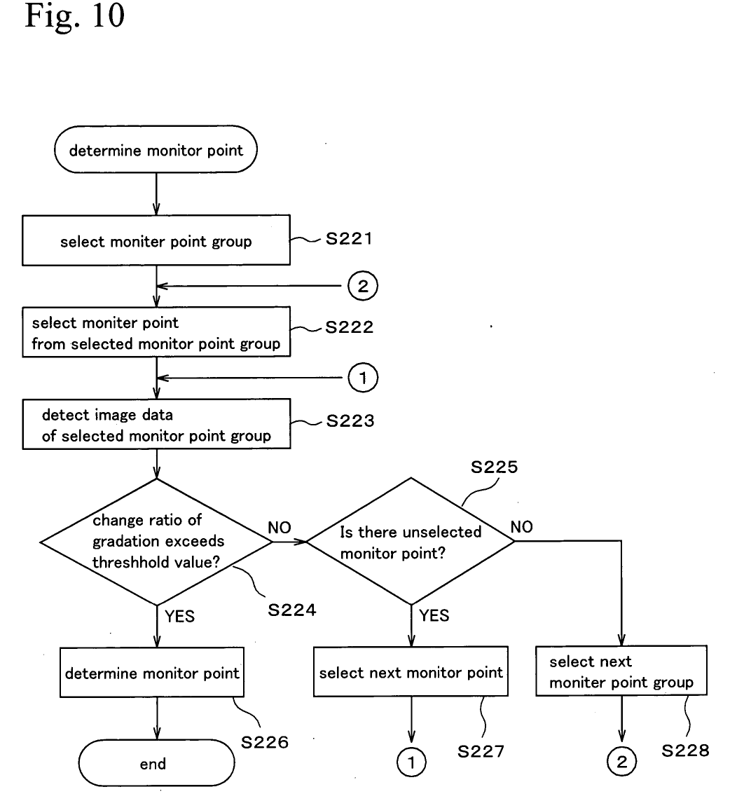

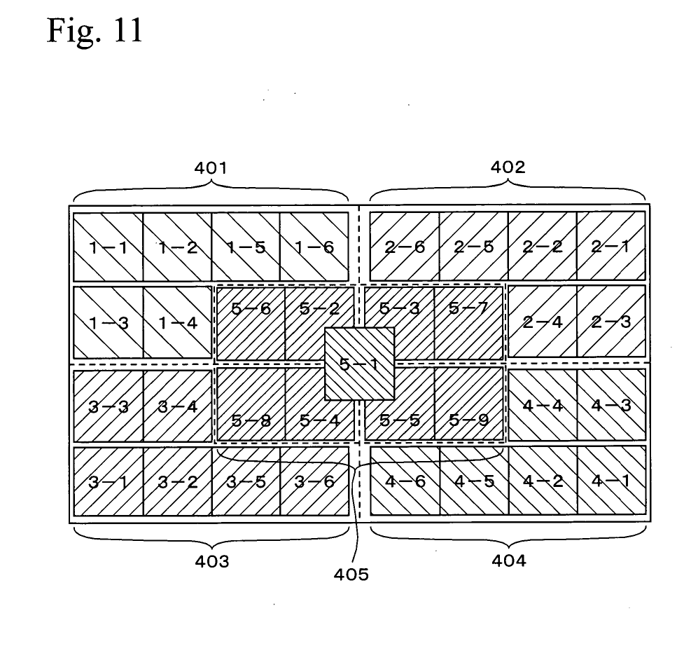

One example of the processing in the step S211 will be described in detail hereinafter. FIG. 10 is a flow chart showing one example of the processing for determining the monitor point. FIG. 11 is a diagram showing one example of the setting condition of the monitor point.

First, setting of the monitor point of the example will be described. In FIG. 11, a photographed view is divided into five monitor point groups, and each monitor point group is divided into plural monitor points.

In the above example, the monitor point groups are set at five regions, that is, an upper left region 401 of the photographed view, an upper right region 402 thereof, a lower left region 403 thereof, a lower right region 404 thereof, and a center region 405 thereof. The monitor point groups 401 to 404 have 8 divided monitor points. The monitor point group 405 has 8 divided monitor points and a monitor point set at a center of the photographed view.

When the monitor points are determined, monitor point groups are selected on an image which is photographed by the photographing device 111 and is input into the image input device 123 at a predetermined sampling timing (in step S221).

For example, the selection of the monitor point groups is performed in order of the monitor point group 401, the monitor point group 402, . . . , the monitor point group 405, and returns to the monitor point group 401.

When the monitor point groups are selected, monitor points are selected from the monitor point group (in step S222). For example, in the case of the monitor point group 401, the selection of the monitor points is performed in order of the monitor point (1-1), the monitor point (1-2), . . . , the monitor point (1-8), and returns to the monitor point (1-1).

When the monitor point is selected, the image data of the selected monitor point is obtained (in step S223), and it is determined whether or not the change ratio of the gradation in the monitor point is above a predetermined value (in step S224).

In this case, it is determined whether or not a gradation difference (a contrast difference) allowing to be used as a characteristic point exists by checking the change ratio of the gradation within the monitor point. For example, in the case in which a specific object is photographed, since the contour portion of the image of the object has a clear gradation difference, the change ratio of the gradation (positional change ratio of the gradation) is large as it is. In the above manner, the predetermined value is set for the change ratio of the gradation at the monitor point, it is determined whether or not the change ratio of the gradation at the monitor point exceeds the predetermined value. As a result, it can be determined whether or not the monitor point is the characteristic point suitable for detecting the movement of the image.

When the determination in the step S224 is YES, it is determined that the monitor point is used for obtaining data for image analysis (in step S226). When the determination in the step S224 is NO, it is determined whether or not monitor points which are not used for detecting image data in the same monitor point group (that is, unselected monitor points) exist (in step S225). When unselected monitor points exist, the next monitor point is selected (in step S227). When no unselected monitor points exist, the next monitor point group is selected (in step S228), and the processing after the step S222 is executed, that is, monitor point allowing to be used as a characteristic point is searched from the monitor point group.

For example, in the step S221, the monitor point group 401 is selected. In this case, first, the monitor point (1-1) is selected in accordance with the selection order set at the monitor point (1-1), the monitor point (1-2), the monitor point (1-3), . . . (in step S222).

Next, image data of the monitor point (1-1) is detected (in step S223), it is determined whether or not the change ratio of the gradation thereat is below the predetermined value (in step S224). In this case, when the change ratio of the gradation thereat is such that the monitor point (1-1) cannot be used as the characteristic point, the determination in the step S224 is NO, and the processing in the step S225 is executed. Since this case is after the monitor point (1-1) is selected in the step S222, the determination in the step S225 is YES, the monitor point (1-2) is selected as a next monitor point (in step S227), and the processing after the step S223 is executed again.

In the above manner, the search at the monitor points of the monitor point group 401 is performed in the determined order untill the monitor point has the positional gradation difference to some extent. Then, in the case in which the monitor point having the positional gradation difference to some extent is not searched, the determination in the step S225 is NO, the monitor point group 402 is selected as a next monitor point group, and the same processing as the case of the monitor point group 401 is executed.

In the above manner, the search at each monitor point of each monitor point group is sequentially performed in the determined order untill the monitor point (for example, an edge portion of an image of a predetermined article) has the positional gradation difference to some extent, so that the monitor point is determined.

According to the Third Embodiment, the region having the gradation difference exceeding the predetermined value is selected as the monitor point. As a result, even when the image indicating device 101 is directed to the portion (for example, the ceiling or the wall) which does not have many characteristic point, the characteristic point is automatically searched, and the change of the directing direction of the image indicating device 101 is detected by using the searched characteristic point, and the motion of the point image 103 can be controlled based on the detected result.

As a result, even when the image indicating device 101 is directed to the ceiling or the wall which does not have many characteristic point, it is easy to control the position of the point image 103. In a presentation in a dark place, it is also easy to control the position of the point image 103.

Although one characteristic point is selected in the above described example, plural characteristic points may be selected.

### (4) Fourth Embodiment

In the Fourth Embodiment of the present invention, the same components as in the Second and the Third Embodiments are given the same reference numerals, and the description of the structures and the actions thereof are omitted.

### (4-1) Structure of Fourth Embodiment

In the Fourth Embodiment of the present invention, a graphical user interface (GUI) function of a personal computer is combined with the position control technique of the point image of Third Embodiment. The GUI is a user interface such that substantial graphics for displaying information for users are used and operations of the application soft can be performed by a pointing device such as a mouse.

That is, in the Fourth Embodiment, the position control of the point image 310 is performed by using a control function of a point image (mouse pointer) of a common personal computer in the same manner as in the Second Embodiment shown in FIGS. 7 and 8. In this point, the Fourth Embodiment is different from the Third Embodiment in which the point image is synthesized by the external device with the image generated by the personal computer. In the Fourth Embodiment, it is possible to operate the GUI function using the point image since the point image control function of the personal computer is used.

### (2-2) Action of Second Embodiment

In the Fourth Embodiment, the processing by the image analyzing device 208 and the point image control signal generating device 209 shown in FIG. 8 is the same as that by the image analyzing device 126 and the point image control signal generating device 127 in the Third Embodiment. The actions of the devices except for the image analyzing device 208 and the point image control signal generating device 209 is the same as those in the Second Embodiment.

### (5) Fifth Embodiment

In the Fifth Embodiment of the present invention, the same components as in the First Embodiment are given the same reference numeral, and the description of the structures and the actions thereof are omitted.

### (5-1) Structure of the Fifth Embodiment

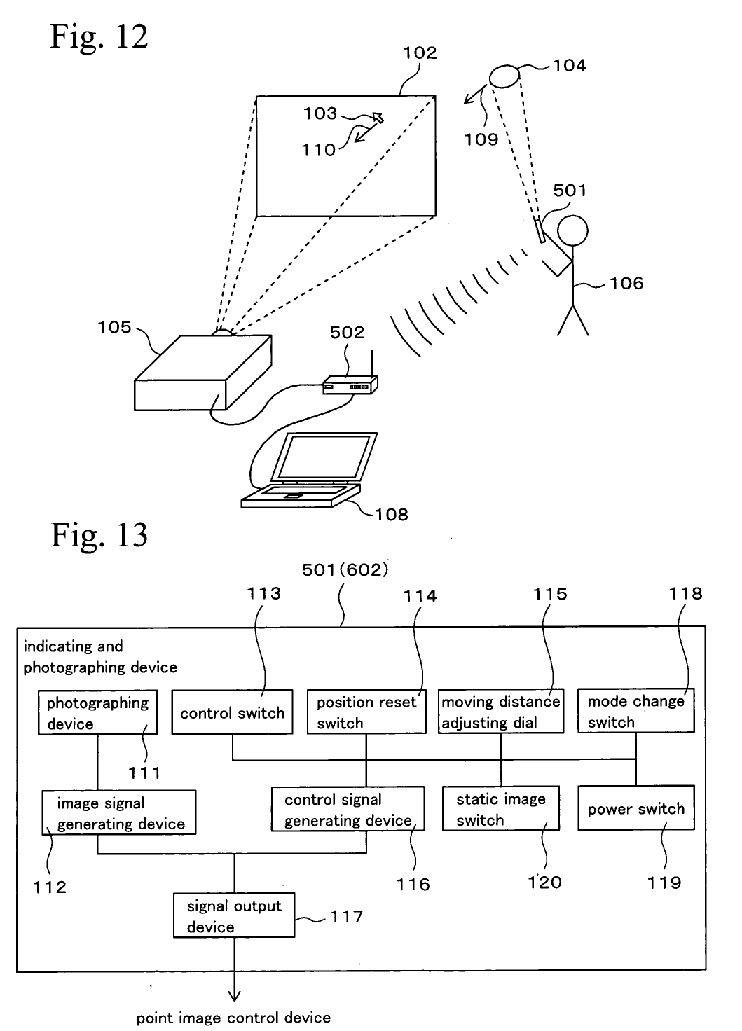

FIG. 12 is a conceptual diagram showing a presentation system having a pointing device of the Fifth Embodiment according to the present invention. In FIG. 12, reference numeral 501 denotes an indicating and photographing device, reference numeral 102 denotes a screen, reference numeral 103 denotes a point image, reference numeral 104 denotes a range of a photographed target of the indicating and photographing device 501, and reference numeral 105 denotes a projecting device, reference numeral 106 denotes a speaker (a presenter who is performing a presentation), reference numeral 502 denotes a point image control device, and reference numeral 108 denotes a personal computer. In FIG. 12, the components except for the indicating and photographing device 501 and the point image control device 502 are the same as those in FIG. 1.

In the above presentation system, the indicating and photographing device 501 can be used in a photographed image display mode or a point image control mode. In the case in which the photographed image display mode is selected, indicating and photographing device 501 is used as a camera for photographing an arbitrary target. In this case, a photographed image by the indicating and photographing device 501 can be projected onto the screen. In the case in which the point image control mode is selected, when the speaker moves the indicating and photographing device 501, the point image 103 projected onto the screen can be moved in accordance with the motion of the indicating and photographing device 501. In this case, the point image control device 502 analyzes the motion of the indicating and photographing device 501 within a photographed view of an image photographed by the indicating and photographing device 501, whereby the moving direction and the moving distance of the point image 103 are calculated, and the position of the displayed point image 103 is controlled in accordance with the calculated result.

The indicating and photographing device 501 transmits various control signals to the point image control device 502. A signal for selecting the photographed image display mode or the point image control mode is contained in the control signals.

The point image control device 502 transmits an image photographed by the indicating and photographing device 501 to the projecting device 105. The point image control device 502 transmits an image photographed by the indicating and photographing device 501 as a static image to the projecting device 105. The point image control device 502 controls the position of the point image 103 on the screen 102 based on the signal transmitted from the indicating and photographing device 501. In addition, the point image control device 107 synthesizes a point image with an image transmitted from the personal computer 108.

FIG. 13 is a block diagram showing an example of a structure of the indicating and photographing device 501. The indicating and photographing device 501 shown in FIG. 13 is equipped with a photographing device 111, an image signal generating device 112, a control switch 113, a position reset switch 114, a moving distance adjusting dial 115, a mode change switch 118, a power switch 119, an image static device 120, a control signal generating device 116, and a signal output device 117. In FIG. 13, components except for the mode change switch 118, the power switch 119, and the image static device 120 are the same components as those shown in FIG. 2 in the First Embodiment.

The mode change switch 118 has a function for selecting the photographed image display mode or the point image control mode. By operating the mode change switch 118, a signal for selecting the photographed image display mode or the point image control mode is generated by the control signal generating device 116.

The power switch 119 is a power switch of the indicating and photographing device 501. The image static switch 120 is a switch for photographing by the photographing device 111 and making an image projected onto the screen 102 be a static image.

The control signal generating device 116 converts operating contents of the control switch 113, the position rest switch 114, the moving distance adjusting dial 115, the mode change switch 118, the power switch 119, and the image static switch 120 to appropriate signals for transmitting the above operation contents to the point image control device 502.

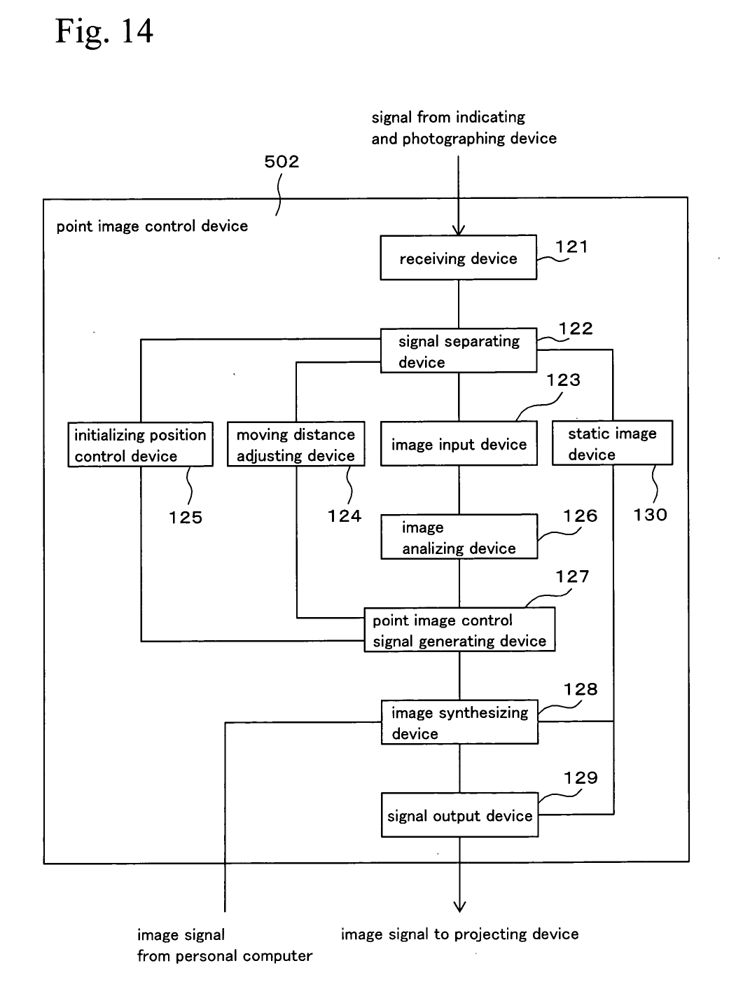

FIG. 14 is a block diagram showing an example of a structure of the point image control device 502 shown in FIG. 12. The point image control device 502 as shown in FIG. 14 is equipped with a receiving device 121, a signal separating device 122, an image input device 123, a moving distance adjusting device 124, an initializing position control device 125, an image analyzing device 126, a point image control signal generating device 127, an image static device 130, an image synthesizing device 128, and a signal output device 129. In FIG. 14, the components except for the image static device 130 are the same as those in FIG. 3 in the First Embodiment.

The static image device 128 obtains an image photographed by the indicating and photographing device 501 at arbitrary timing and makes the obtained image be a static image. For example, in the case in which an image photographing mode is selected and an arbitrary target is photographed, when the static image switch 120 shown in FIG. 13 is pressed, an image projected and displayed onto the screen 102 shown in FIG. 12 is simultaneously set as a static image.

The static image device 128 is equipped with a memory (not shown in the Figures). In the memory, images photographed by the indicating and photographing device 501 at a predetermined sampling interval are repeatedly stored, and the stored image data are maintained for a predetermined period of time. In the static image processing, the image data maintained in the memory are read and are transmitted to the signal output device.

In the Fifth Embodiment, an optical zoom function of the projecting device 105 may be operated by the indicating and photographing device 501. In this case, the indicating and photographing device 501 is further equipped with a zoom adjusting operation switch, and the point image control device 502 is further equipped with a zoom adjusting signal generating device. In this structure, the zoom adjusting operating switch of the indicating and photographing device 501 is operated, a signal reflected by the operation of the zoom adjusting operating switch is transmitted to the point image control device 502, a control signal for controlling the optical zoom function of the projecting device 105 is generated by the zoom adjusting signal generating device of the point image control device 502 in accordance with the received signal reflected by the operation of the zoom adjusting operating switch, and the optical zoom function of the projecting device 105 is controlled by the control signal generated by the zoom adjusting signal generating device.

The indicating and photographing device 501 may be equipped with an image display device. In this case, the speaker can watch an image photographed by the photographing device 111 at hand. Apart or a whole of the point image control device 502 is housed in the indicating and photographing device 501.

### (5-2) Action of the Fifth Embodiment

### (5-2-1) Outline of Action of the Fifth Embodiment

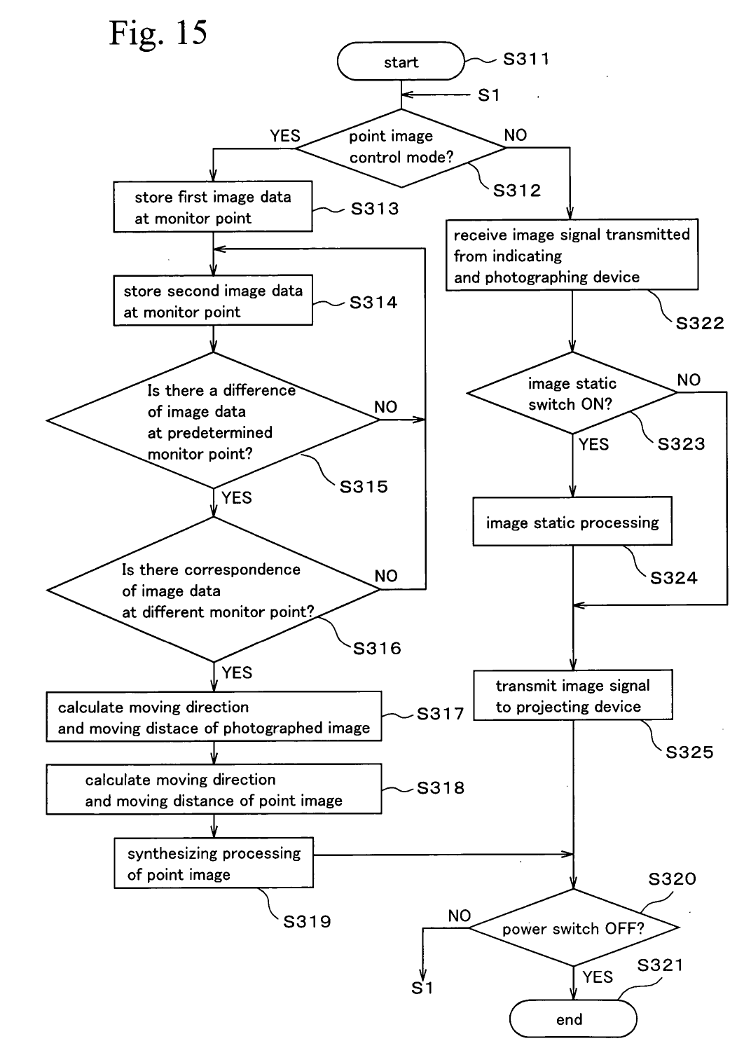

FIG. 15 is a flow chart showing one example of the action of the indicating and photographing device 501. In the presentation system shown in FIG. 12, by using one example in which the speaker (presenter) performs by using the indicating and photographing device 501, the example of the action of the action of the Fifth Embodiment will be described hereinafter. In the example, the processing shown in FIG. 15 is executed in the point image control device 502.

In the presentation system shown in FIG. 12, the speaker 106 has the indicating and photographing device 501 with his hand, switches the power switch 119 shown in FIG. 13 ON, image data generated by the photographing device 111 is transmitted to the point image control device 502, and the processing shown in FIG. 15 starts (in step S311). When the power switch 119 is switched ON, the control signals reflected by the operation contents of the control switch are generated by the control signal generating device 116, and are transmitted from the signal output device 117 to the point image control device 502. The point image control device 502 executes the following processing based on the various control signals transmitted from the indicating and photographing device 501.

When the processing shown in FIG. 15 starts, it is determined whether or not the mode change switch 118 of the indicating and photographing device 501 is set in the point image control mode (in step S312). When the mode change switch 118 is set in the point image control mode, the processing goes to step S313. When the mode change switch 118 is set in the photographed image display mode, the processing goes to step S322.

In steps S313 to S319, the position of the point image 103 is controlled in the point image control mode. In the point image control mode, the processing is executed in the same manner as in the First Embodiment.

When the determination in the step S312 is NO, the processing goes to step S322, and the processing in the photographed image display mode is executed. In the photographed image display mode, image data signal transmitted from the indicating and photographing device 501 is received by the receiving device 121 shown in FIG. 14 (in step S322), and it is determined whether or not the static image switch 120 shown in FIG. 13 is switched ON (in step S323).

When the static image switch 120 is pressed, the processing in which an image displayed on the screen 102 is statically displayed is executed by the static image device 128 (in step S324). When the static image switch 120 is not pressed, the image data signal transmitted from the indicating and photographing device 501 is transmitted from the signal output device 130 to the projecting device 105 (in step S325).

Then, it is determined whether or not the power switch 119 is switched OFF (in step S320). In the step S320, when the power switch 119 is not switched OFF, the processing returns to the step S312. In this case, when the power switch 119 is switched OFF, the processing ends (in step S321).

In the above feature, the image signal of the image photographed by the indicating and photographing device 501 is transmitted to the projecting device 105 via the point image control device 502. Then, the image is projected from projecting device 105, and is displayed onto the screen 102. That is, the image photographed by the indicating and photographing device 501 can be projected and displayed onto the screen 102. When the static image switch 120 is switched ON, the projected and displayed image can be displayed as a static image. As a result, for example, the speaker 106 photographs a material with his hand by using the indicating and photographing device 501, and presses the static image switch 120 at an appropriate time, whereby the photographed image can be displayed on the screen 102 as a static image.

By operating the static image switch 120, a frame of the photographed image divided at an arbitrary time is projected and displayed on the screen 102. After that, by operating the mode change switch 118, the mode is switched to the point image control mode, and the presentation can be performed such that the static image projected and displayed on the screen 102 is indicated by the point image 103.

In the above manner in which the mode is switched by operating the indicating and photographing device 501, the display operation for displaying the photographed image on the screen 102 and the position control operation for the point image 103 can be easily and appropriately performed. Therefore, in the presentation, the speaker can easily use photographed images photographed by himself there. In the point image control mode, it is unnecessary to direct the indicating and photographing device 501 to the screen 102. The position of the point image 103 can be controlled by directing and moving the indicating and photographing device 501 at an appropriate and freely selected location. As a result, the problem with the laser pointer that the laser beam may be irradiated into the eyes of the audience does not occur. The motion of the speaker is not restricted in the presentation.

### (5-2-2) Details of Point Image Control

One example of the point image control mode executed in the steps S313 to S319 shown in FIG. 15 is the same as the method explained by using FIG. 5 in the First Embodiment.

In the above case, since the mode change switch is set in the point image control mode, when the power switch 119 is not switched OFF, the determination in the step S320 is NO, and the determination in the step S312 is YES, so that the processing after the step S313 is repeatedly executed. In the above manner, when the directing direction of the indicating and photographing device 501 is changed, the processing for moving the point image 103 in accordance with the change of the directing direction is repeatedly executed. That is, the position control of the point image 103 is performed in accordance with the motion of the photographed image.

When the power switch 119 is switched OFF, the processing goes to step S321 based on the determination in the step S320, and the processing ends. When the mode is switched to the photographed image display mode, the position control of the point image 103 is not performed, and the processing after the step S322 is executed.

A more concrete example of the position control of the point image 103 is the same as the method in the First Embodiment.

One detailed example of the above action will be explained hereinafter. When the speaker 106 shown in FIG. 12 operates the position reset switch 114 shown in FIG. 13, a signal for instructing based on the above operation is generated by the control signal generating device 116, and is transmitted from the signal output device 117 to the point image control device 502 shown in FIGS. 12 and 14. The signal is received by the receiving device 121 of the point image control device 502, and is transmitted to the initializing position control device 125 via the signal separating device 122. In the initializing position control device 125, based on the signal transmitted thereto, a signal for displaying the point image 103 at a predetermined position on the screen (for example, a center of the screen 102) is transmitted to the point image control signal generating device 127. In the point image control signal generating device 127, based on the signal transmitted thereto, a signal for displaying the point image at the predetermined position on the screen 102 is generated, and is transmitted to the image synthesizing device 128. Then, in the image synthesizing device 128, a synthesized image is made such that the point image 103 is displayed at the center of an image transmitted from the personal computer 108, and the synthesized image data is transmitted to the projecting device 105. The synthesized image is projected by the projecting device 105 onto the screen 102. In the above manner, the point image 103 is forcibly displayed at the center of the screen 102.

In the above feature, the same actions and effects as in the case in the First Embodiment can be obtained.

In the Fifth Embodiment, the point image control mode explained by using FIGS. 9 to 11 in the Third Embodiment can be used instead of that explained by using FIGS. 4 to 6 in the First Embodiment.

### (6) Sixth Embodiment

In the Sixth Embodiment of the present invention, the same components as in the Second and Fifth Embodiments are given the same reference numerals, and the explanations of the structures and the actions thereof are omitted.

### (6-1) Structure of the Sixth Embodiment

In the Sixth Embodiment, a graphical user interface (GUI) function of a personal computer is combined with the position control technique of the point image of the Fifth Embodiment according to the present invention.

In the Sixth Embodiment, for example, the present invention is applied to a system in which a point image is projected and displayed on a screen by using a control function of a point image (mouse pointer) of a common personal computer.

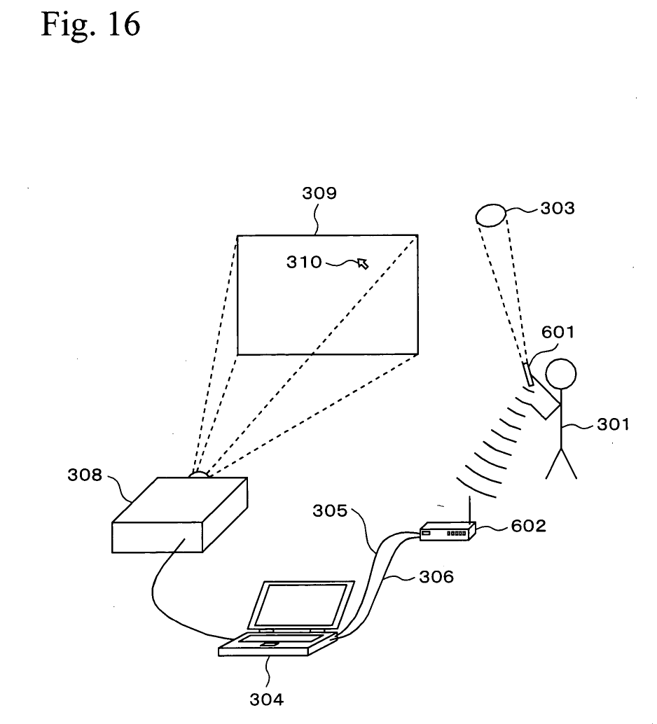

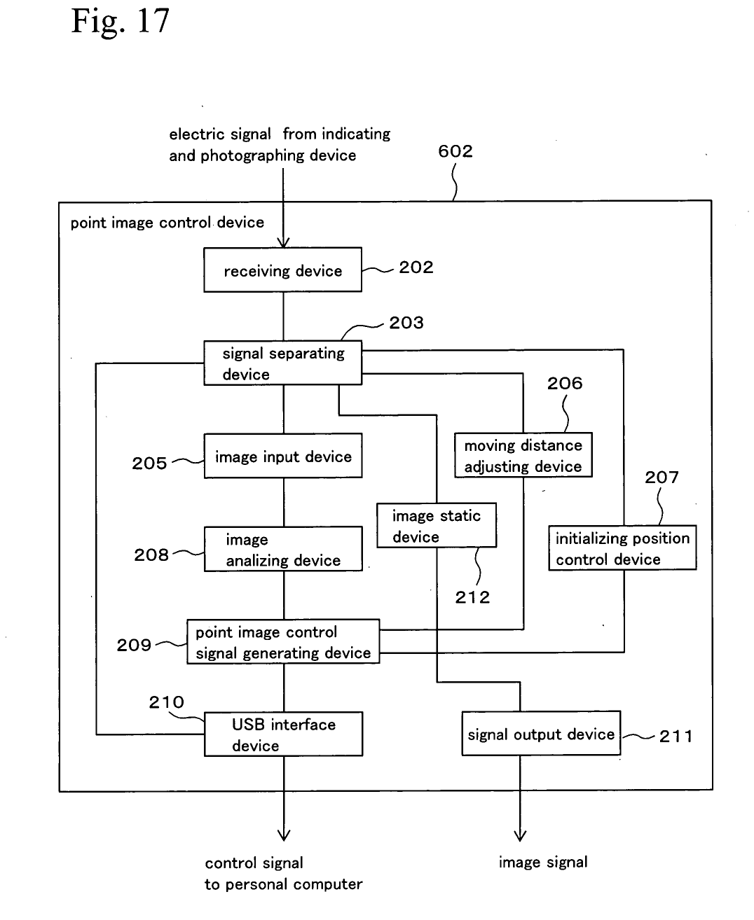

FIG. 16 is a conceptual diagram showing another presentation system in which the pointing device of the Sixth Embodiment according to the present invention is used. FIG. 17 is a block diagram showing one example of a structure of a point image control device 602 shown in FIG. 16.

In FIG. 16, reference numeral 301 denotes a speaker, reference numeral 601 denotes an indicating and photographing device, reference numeral 303 denotes a range of a photographed target photographed by the indicating and photographing device 601, reference numeral 602 denotes a point image control device, reference numeral 304 denotes a personal computer, reference numeral 305 denotes a USB cable, reference numeral 306 denotes an image transmission cable, reference numeral 308 denotes a projecting device, reference numeral 309 denotes a screen, and reference numeral 310 denotes a point image.

The indicating and photographing device 601 has the same structure as that shown in FIG. 13. As shown in FIG. 17, the point image control device 602 is equipped with a receiving device 202, a signal separating device 203, an image input device 205, a moving distance adjusting device 206, an initializing position control device 207, an image analyzing device 208, a point image control signal generating device 209, a USB interface device 210, an image static device 212, and a signal output device 211.

Since in FIG. 17, the devices except for the USB interface device 210 have the same structures as those shown in FIG. 14, the explanations thereof are omitted. The USB interface device 210 generates a signal of USB Standards for determining a position of a point image, and transmits the signal to the personal computer 304 shown in FIG. 16. The USB interface device 210 converts a right click operation signal and a left click operation signal, which are generated by using a point image and are transmitted from the indicating and photographing device 601 shown in FIG. 16, to a signal of USB Standards, and transmits the signal to the personal computer 304 shown in FIG. 16.

In the Sixth Embodiment, the photographed image display mode or the point image control mode can be selected by operating the indicating and photographing device 601. In the case in which the point image control mode is selected, the graphical user interface (GUI) can be operated on the display image on the screen 309 by using the point image 310.

In the case in which the photographed image display mode is selected, an image photographed by the indicating and photographing device 601 is analyzed in the point image control device 602, so that a moving direction and a moving distance of a photographed object of the indicating and photographing device 601 are calculated. Then, in the point image control device 602, a signal of USB Standards for determining a display position of the point image 310 is generated based on the analyzed result, and is transmitted to the personal computer 304. In the personal computer 304, an image on which the point image is positioned at predetermined coordinates thereof is generated by using a display position control function of a point image of the GUI, is transmitted to the projecting device, and is projected onto the screen 309 by the projecting device 308. In the above manner, the point image 310 can be displayed on the screen 309 by following a movement of the image indicating device 302.

In the Sixth Embodiment, the position control of the point image 310 is performed by using a control function of a point image (mouse pointer) of a common personal computer 304. In the above feature, the Sixth Embodiment is different from the Fifth Embodiment in which the point image is synthesized by the external device with the image generated by the personal computer.

In the Sixth Embodiment, the indicating and photographing device 601 is equipped with plural control switches 113 in the structure shown in FIG. 13, and switches corresponding to right click switch and a left click switch of a common mouse are contained therein for operating the GUI.

A signal which is output from the point image control device 201 and is input into a USB input port of the personal computer 304 is the same as a signal input from a common pointing device (for example, a mouse) to a personal computer. The processing of the personal computer 304 for position control is the same as for a common pointing device. Therefore, it is possible to perform processing by the same right click operation and left click operation as a common mouse by using the indicating and photographing device 601. That is, it is possible to operate the GUI by using the indicating and photographing device 601.

### (6-2) Action of the Sixth Embodiment

In the presentation system shown in FIG. 16, the action when the point image control mode is selected will be described hereinafter. In this case, when the speaker 301 moves the indicating and photographing device 601 so as to change the directing direction thereof, the range 303 of the photographed target is relatively moved, and the image within the photographing view is moved. The image data containing the information of the movement of the image within the photographing view is transmitted from the indicating and photographing device 601 to the point image control device 602. In this case, the action of the point image control device 602 is the same as that of the point image control device 201 in the Second Embodiment. Then, the action of the personal computer 304 and the projecting device is the same as in the Second Embodiment. In the above manner, the position of the point image displayed on the screen 309 can be controlled by changing the directing position of the indicating and photographing device 601.

In the Sixth Embodiment, in the presentation system shown in FIG. 16, the operation of the GUI by using the point image 310 is performed by using the indicating and photographing device 601.

In the structure shown in FIG. 16, the photographed image display mode can be selected by operating the mode change switch 118 shown in FIG. 13. In the case in which the photographed image display mode is selected, the image photographed by the indicating and photographing device 601 is directly projected onto the screen 309. In this case, the image data of the image photographed by the photographing device of the indicating and photographing device 601 is received by the receiving device 202 of the point image control device 602 shown in FIG. 17, and is transmitted from the signal separating device 203 to the signal output device 211 via the static image device 212. The image signal is transmitted by the signal output device 211 to the personal computer 304 via the image transmission cable 306. The image signal is processed by using appropriate application software by the personal computer 304, and is transmitted to the projecting device 303. The image is projected onto the screen 309.

In the Sixth Embodiment, in executing the photographed image display mode, by operating the image static switch 120 shown in FIG. 13, the image which is photographed by the indicating and photographing device 601 and is projected and displayed on the screen 309 can be static.

In the Sixth Embodiment shown in FIG. 16, the moving distance of the point image 310 can be adjusted in accordance with the change of the directing direction of the indicating and photographing device 601. In this case, in the moving distance adjusting device 206 of the point image control device 602 shown in FIG. 17, based on the operation of the moving distance adjusting dial 115 shown in FIG. 13, a signal for setting the moving distance of the point image is generated, and in the point image control signal generating device 209 the processing is performed such that the position of the point image is reflected on the adjusted moving distance.

In the Sixth Embodiment shown in FIG. 16, the point image 310 can be forcibly re-displayed at a predetermined position. In this case, by operating the position reset switch 114 shown in FIG. 13, in the initializing position control device 207 of the point image control device 602 shown in FIG. 17, a signal for forcibly displaying the point image at a predetermined position is generated, and in the point image control signal generating device 209 the processing is performed such that the point image is forcibly displayed at a predetermined position on the image projected onto the screen 309.

### (7) Seventh Embodiment

It is possible to use a common portable telephone with a camera as the indicating and photographing device 501 in the Fifth Embodiment.

In the case in which a portable telephone with a camera is used, a program for executing the processing shown in FIG. 15 is downloaded from an appropriate recording medium or a website to the portable telephone, and the portable telephone is used as the indicating and photographing device 501.

In this case, 10 key inputs of the portable telephone are appropriately replaced as the control switch 113, the position reset switch 114, the moving distance adjusting dial 115, the mode change switch 118, the power switch 119, and the static image switch 120. For example, the functions of the operation switch are assigned such that a button of number “1” is used as the mode change switch, and a button of number “2” is used as the position reset switch to the input functions of the portable telephone.

Signals from the portable telephone to the point image control device 502 may be transmitted by using a telephone circuit, an optical communication, a high frequency signal such as Bluetooth Standards, a optical cable, and other common signal standards.

The Seventh Embodiment can be applied to an operation device for the GUI shown in the Second Embodiment. In this case, the portable telephone with a camera can be used not only as a tool for a presentation but also as a mouse.

### (8) Application of the Embodiment

The pointing devices shown in the Fifth to Seventh Embodiments can also be used in school lessons in addition to presentations.

For example, in common mathematical lessons, a method is used in which a student writes an answer by himself on the blackboard, and the teacher comments on the answer of the student.

In the case in which the structures of the above Embodiments can be used, the following method can be used instead of the above method. First, the teacher sets the indicating and photographing device 501 in the photographed image display mode, the photographing device 111 photographs a notebook of a student, and the projecting device 105 projects the photographed image onto the screen 102. Then, the teacher presses the static image switch 120 at an appropriate time in the state in which the photographed image of the notebook of the student is displayed, so that the image is statically displayed.

Next, the teacher switches the mode of the indicating and photographing device to the point image control mode by operating the mode change switch 118. As a result, since the display position of the point image 103 displayed on the screen can be controlled, the teacher moves the indicating and photographing device 501, so that the position of the point image 103 can be controlled. Therefore, the lesson can be performed such that the teacher photographs the notebook of the student beforehand, and explains or comments on the content of the notebook while pointing to the notebook by using the point image 103.

The Embodiments can be used for presentations and lessons in which images are displayed on an image display device such as a screen.

1. A pointing device comprising:
an image indicating device for operating a point image;
a photographing device for photographing, which is provided in the image indicating device;
an image movement detecting device for detecting a movement of a photographed image photographed by the photographing device;
a calculating device for calculating a moving direction and a moving distance of the point image corresponding to the movement of the photographed image; and
a signal generating device for generating a signal for synthesizing the point image with a displayed image,
wherein the position of the displayed point image is moved in accordance with the movement of the photographed image by the photographing device.

2. The pointing device according to claim 1,
wherein the pointing device has plural monitor points which are set within the photographed image;
the image movement detecting device stores first image data at one or more monitor points at a predetermined time,
compares second image data which is obtained at the plural monitor points after the predetermined time with the stored first image data,
detects difference between the first image data and the second image data based on the result of the comparison, and
calculates the moving direction and the moving distance of the photographed image based on the difference between the first image data and the second image data.

3. The pointing device according to claim 1,
wherein the monitor point is a set of pixels divided into a matrix.

4. The pointing device according to claim 1,
the pointing device further comprising:
a moving distance adjusting device for adjusting the moving distance of the point image corresponding to the moving distance of the photographed image.

5. The pointing device according to claim 1,
the pointing device further comprising:
a control signal generating device for generating a control signal for controlling a graphical user interface operating device.

6. A method for displaying a point image comprising:
an image movement detecting step for detecting a movement of a photographed image;
a calculating step for calculating a moving direction and a moving distance of a point image corresponding to the movement of the photographed image; and
a signal generating step for generating a signal for synthesizing the point image with a displayed image based on the result of calculation in the calculating step.

7. A pointing device comprising:
an image indicating device for operating a point image:
a photographing device for photographing, which is provided in the image indicating device;
an image movement detecting device for detecting a movement of a photographed image which is photographed by the photographing device within a photographed view;
a calculating device for calculating a moving direction and a moving distance of a point image corresponding to the movement of the photographed image; and
a signal generating device for generating a signal for synthesizing the point image with a displayed image,
wherein the image movement detecting device selects one or more regions as monitor points which have a gradation difference exceeding a predetermined level among each location of the photographed image.

8. The pointing device according to claim 7,
wherein the image movement detecting device selects monitor points from an image photographed in first photographing,
obtains a monitoring pattern of the monitor points selected from the image photographed in first photographing,
searches the monitoring pattern from an image photographed in second photographing performed after a predetermined period of time passes from the first photographing,
detects the positional change of the monitoring pattern within the photographed view by comparing the coordinates of the obtained monitoring pattern and the coordinates of the searched monitoring pattern, and
calculates a moving direction and a moving distance of the photographed image within the photographed view based on the result of detection of the positional change.

9. The pointing device according to claim 7,
the pointing device further comprising:
a moving distance adjusting device for adjusting a moving distance of the point image corresponding to the moving distance of the photographed image.

10. The pointing device according to claim 7,
the pointing device further comprising:
a control signal generating device for generating a control signal for controlling a graphical user interface operating device.

11. A method for displaying a point image, comprising:
an image movement detecting step for detecting a movement of a photographed image by a photographing device provided in an image indicating device;
a calculating step for calculating a moving direction and a moving distance of a point image corresponding to the movement of the photographed image; and
a signal generating step for generating a signal for synthesizing the point image with a displayed image based on the result of calculation in the calculating step,
wherein the image movement detecting step includes a step of selecting one or more regions as monitor points which have a gradation difference exceeding a predetermined level among each location of the photographed image.

12. The method for displaying a point image according to claim 11,
wherein the image movement detecting step includes steps of:
selecting monitor points from a first photographed image photographed in first photographing;
obtaining a monitoring pattern of the monitor points selected from the first photographed image photographed in first photographing;
searching the monitoring pattern from a second photographed image photographed in second photographing performed after a predetermined period of time passes from the first photographing;
detecting the positional change of the monitoring pattern within the photographed view by comparing the coordinates of the obtained monitoring pattern and the coordinates of the searched monitoring pattern; and
calculating a moving direction and a moving distance of the photographed image within the photographed view based on the result of detection of the positional change.

13. A pointing device comprising:
a photographing device for photographing;
a point image control mode for detecting the change of the directing direction of the photographing device based on a moving distance and a moving direction of an image photographed by the photographing device within a photographed view and determining a position of a point image on a display screen in accordance with the result of the detected change;
a photographed image display mode for displaying a photographed image by the photographing device on the display screen; and
a mode selecting signal generating device for generating a signal for selecting either the point image control mode or the photographed image display mode.

14. The pointing device according to claim 13,
wherein the pointing device further comprising:
a static image signal generating device for generating a signal for executing a static image processing for making a displayed image be static in the photographed image display mode.

15. The pointing device according to claim 13,
wherein the pointing device further comprising:
a display device for displaying an image photographed by the photographing device.

16. The pointing device according to claim 13,
the pointing device further comprising:
a moving distance adjusting device for adjusting a moving distance of the point image corresponding to the moving distance of the photographed image.

17. The pointing device according to claim 13,
the pointing device further comprising:
a control signal generating device for generating a control signal for controlling a graphical user interface operating device.

18. A program for a computer which controls so as to determine a position of a point image indicating a freely selected position on a display screen, comprising the steps of:
selecting a photographed image mode or a point image control mode, the photographed image display mode for displaying an image photographed by the photographing device on the display screen, the point image control mode for detecting a change of a directing direction of a photographing device based on a moving distance and a moving direction of a photographed image by the photographing device within a photographed view and determining the position of the point image on the display screen in accordance with the result of the detected change;
transmitting image data for displaying an image photographed by the photographing device on the display screen in a case in which the photographed image display mode is selected; and
transmitting image data for controlling the position of the displayed point image in a case in which the point image control mode is selected.
